(19) United States
(12) Patent Application Publication
(10) Pub. No.: US 2023/0096680 A1
(43) Pub. Date: Mar. 30, 2023

(54) INFORMATION PROCESSING DEVICE AND INFORMATION PROCESSING METHOD

(71) Applicant: TOSHIBA TEC KABUSHIKI KAISHA, Tokyo (JP)

(72) Inventor: Sho TSUCHIYA, Tagata Shizuoka (JP)

(21) Appl. No.: 17/885,352

(22) Filed: Aug. 10, 2022

(30) Foreign Application Priority Data
Sep. 22, 2021 (JP) 2021-154212

(51) Int. Cl. G06Q 20/32; G06Q 20/18; G06Q 20/20; G06Q 20/42

(52) U.S. Cl. CPC G06Q 20/3223; G06Q 20/18; G06Q 20/42; G06Q 20/204

(57) ABSTRACT

An information processing device in a POS system in which a commodity can be registered and a payment request can be issued using a mobile terminal operated by a customer, includes a memory that stores flag data indicating a first value indicating that none of registered commodities requires confirmation by a store clerk when payment is made or a second value indicating that at least one registered commodity requires the confirmation, and a processor configured to, when a transaction is started, initialize the flag data to the first value, upon receipt of a request for registering a commodity, determine whether the commodity requires the confirmation, upon determining that the commodity requires the confirmation, update the flag data to the second value, and upon receipt of a payment request, when the flag data indicates the second value, issue a notification for notifying a store clerk that confirmation is required.

### CROSS-REFERENCE TO RELATED APPLICATION

This application is based upon and claims the benefit of priority from Japanese Patent Application No. 2021-154212, filed Sep. 22, 2021, the entire contents of which are incorporated herein by reference.

### FIELD

Embodiments described herein relate generally to an information processing device, a method performed by an information processing device, and a point of sales (POS) system.

### BACKGROUND

A transaction processing system such as a cart POS system or a smartphone POS system in which a commodity sold in a store can be registered for purchase using a terminal device operated by a customer is known.

In such a system, if a payment method such as credit card payment or barcode payment is used, a payment process can be completed by an operation of a customer on a terminal device. Similarly, a payment process can be completed by an operation of a customer through a self-service type checkout machine. Thus, it is possible to complete a sales transaction without involvement of a store clerk.

However, some commodities may need to be confirmed or verified by a clerk due to circumstances such as age restrictions. If a transaction includes a commodity that needs to be confirmed by a clerk, there is a risk that a clerk may miss the necessary confirmation when commodities at the store are otherwise normally purchased without involvement of a clerk.

Under these circumstances, it was desired to be able to notify a clerk of a transaction that includes a commodity that needs to be confirmed by a clerk before the transaction is completed.

### BREIF DESCRIPTION OF THE DRAWINGS

FIG. 1 is a schematic block diagram of a transaction processing system according to an embodiment.

FIG. 2 is a hardware block diagram of a store server.

FIG. 3 is a hardware block diagram of a virtual POS server.

FIG. 4 is a hardware block diagram of a mobile controller.

FIG. 5 depicts a data structure of data records included in a transaction management database.

FIG. 6 depicts a data structure of data records included in a registration database.

FIG. 7 is a hardware block diagram of a user terminal.

FIG. 8 is a hardware block diagram of a monitoring terminal.

FIGS. 9-13 are flowcharts of user interface processing performed by a monitoring terminal.

FIGS. 14-17 are flowcharts of transaction assisting processing performed by a mobile controller.

FIG. 18 is a diagram showing an example of a list screen.

FIG. 19 is a diagram showing an example of a registration screen.

FIGS. 20 and 21 are diagrams each showing an example of a list screen.

FIG. 22 is a diagram showing an example of a guidance screen.

FIG. 23 is a diagram showing an example of a confirmation screen.

FIG. 24 is a diagram showing an example of a release screen.

FIG. 25 is a flowchart of monitoring assisting processing performed by a mobile controller.

FIG. 26 is a diagram showing an outline of an entire monitoring screen.

FIG. 27 is a diagram showing one detail of a display area shown in a monitoring screen.

FIG. 28 is a diagram showing an example of a warning screen.

FIG. 29 is a diagram showing an example of a checkout screen.

### DETAILED DESCRIPTION

Embodiments of the present disclosure provide an information processing device and an information processing method that can notify a clerk recognize of a transaction in which a commodity that needs to be confirmed by a clerk is included in commodities to be purchased in advance.

In general, according to one embodiment, an information processing device is used in a point of sales (POS) system in which a commodity can be registered for purchase and a payment request for the commodity can be issued using a mobile terminal operated by a customer in a store. The information processing device includes a memory that stores flag data indicating either a first value indicating that none of commodities that have been registered requires confirmation by a store clerk when payment is made or a second value indicating that at least one of the commodities requires the confirmation. The information processing device further includes a processor configured to, when a sales transaction is started by the customer using the mobile terminal, initialize the flag data to the first value, upon receipt of a request for registering a commodity from the mobile terminal, determine whether the commodity requires confirmation by a store clerk, upon determining that the commodity requires the confirmation, update the flag data to the second value, and upon receipt of a payment request in association with the transaction, when the flag data indicates the second value, issue a notification for notifying a store clerk that confirmation is required before completing the transaction.

Hereinafter, a transaction processing system according to one or more example embodiments will be described with reference to the drawings.

The transaction processing system in one embodiment performs transaction processing of commodities in a store that sells various commodities including at least one or more commodity that needs a pre-purchase confirmation or verification by a clerk (hereinafter referred to as a “confirmation-required commodity”) due to circumstances such as an age restriction required under applicable laws.

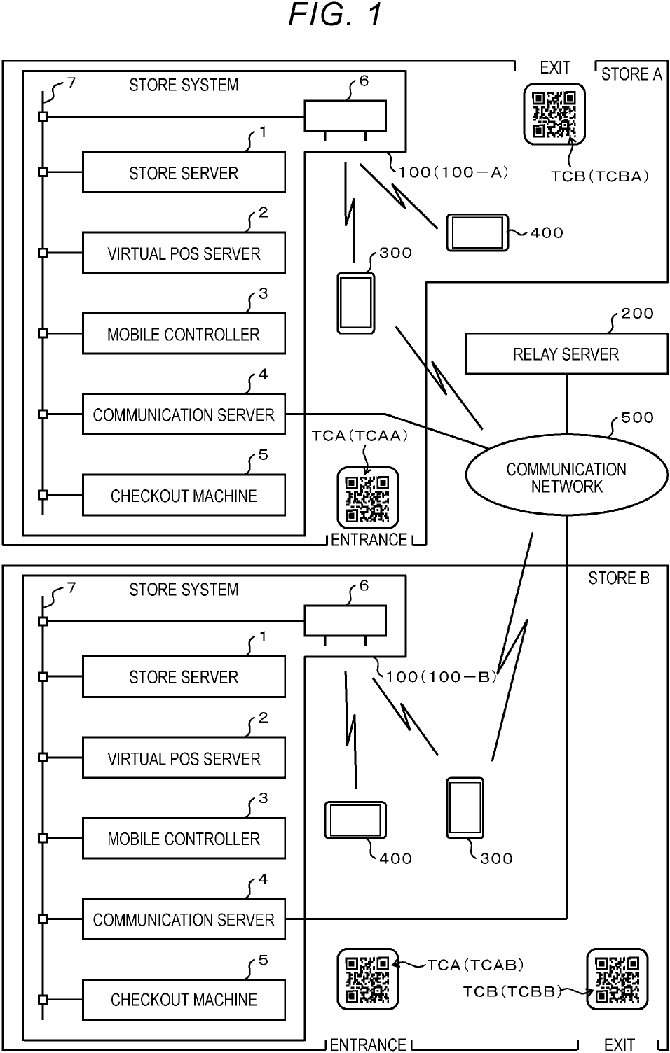

FIG. 1 is a schematic block diagram of a transaction processing system according to an embodiment.

The transaction processing system is configured so that a plurality of store systems 100, a relay server 200, and a user terminal 300 can communicate with each other via a communication network 500. The transaction processing system also includes a monitoring terminal 400.

FIG. 1 shows two store systems 100. These store systems 100 are provided in different stores A and B that use the transaction processing system. There may be three or more stores that use the transaction processing system and each store is provided with the store system 100. In the following, if it is necessary to distinguish between the store systems 100 provided in each respective store, the store system 100 provided in the store A is referred to as a store system 100-A, and the store system 100 provided in the store B is referred to as a store system 100-B.

The business operator that operates the store A may be the same as or different from the business operator that operates the store B. Even if the transaction processing system is used in other stores, the business operators that operate the stores may be the same as or different from the business operator that operates the store A or the store B.

The relay server 200 relays data communication between the user terminal 300 and the store system 100. The relay server 200 provides, for example, a data communication relay function as a cloud service via the communication network 500.

The user terminal 300 is an information communication terminal that functions as a user interface for customers who do shopping using the transaction processing system at a store. The user terminal 300 is a mobile terminal that can be moved during the shopping. The user terminal 300 has a function of wirelessly communicating with the store system 100 and a function of wirelessly communicating with the communication network 500. As the user terminal 300, a communication terminal having a data communication function, such as a smartphone or a tablet terminal can be used. The user terminal 300 may be owned by the customer or lent to the customer at the store.

The monitoring terminal 400 is an information terminal device for assisting a store clerk in the monitoring of, for example, the operating state(s) of the user terminal 300. As the monitoring terminal 400, a communication terminal having a data communication function such as a smartphone or a tablet terminal can be used. As the monitoring terminal 400, a stationary computer device or the like having a data communication function may be used. The monitoring terminal 400 is operated by a clerk or other store employee.

As the communication network 500, for example, the Internet, a virtual private network (VPN), a local area network (LAN), a public communication network, a mobile communication network, or the like can be used alone or in combination as appropriate. As the communication network 500, a mobile communication network and the Internet or VPN are typically used.

The schematic configuration of each store system 100 is substantially the same for each store. The store system 100 is configured so that a store server 1, a virtual POS server 2, a mobile controller 3, a communication server 4, a checkout machine 5, and an access point 6 can communicate with each other via an in-store communication network 7. However, the store server 1, the virtual POS server 2, the mobile controller 3, the communication server 4, the checkout machine 5, the access point 6, and the in-store communication network 7 only need to share the same functions described later and do not have to be completely the same. Some store systems 100 may include one or more additional devices beyond those in FIG. 1.

The store server 1 comprehensively manages a plurality of transactions targeted for a transaction processing performed by the store system 100 as described later. The store server 1 has, for example, a function similar to that of an existing POS server.

The virtual POS server 2 performs information processing for registering purchased commodities for each transaction and settling the price of the purchased commodities in response to an external request. That is, the virtual POS server 2 virtually performs the functions of an existing POS terminal installed in a store. The information processing performed by the virtual POS server 2 is customized to adapt to the difference in the management policy of each store. That is, for example, the information processing performed by the store server 1 provided in the store system 100-A and the information processing performed by the store server 1 provided in the store system 100-B may be partially different.

The mobile controller 3 provides assistance for performing the above information processing by the virtual POS server 2 while using the user terminal 300 as a user interface device.

The communication server 4 performs communication processing for the store server 1, the virtual POS server 2, the mobile controller 3, and the checkout machine 5 to exchange data with the relay server 200 and the like via the communication network 500.

The checkout machine 5 requests payment for purchased commodities for each transaction managed by the virtual POS server 2 and performs a payment process for the customer to make the payment. The payment methods that the checkout machine 5 can accept may be all or any of the well-known payment methods such as cash payment, credit card payment, electronic money payment, point payment, code payment (also referred to as mobile payment or smartphone payment, and the like). The checkout machine 5 may be operated by either a clerk or a customer. As the checkout machine 5, for example, a self-service type checkout machine used in an existing semi-self-service type POS system can be used. The checkout machine 5 may have the function of performing information processing for registering a commodity as a purchased commodity. In such a case, as the checkout machine 5, for example, a manned POS terminal used in an existing POS system or a self-service type POS terminal used in an existing self-service type POS system can be used.

The access point 6 performs communication processing for enabling the user terminal 300 and the monitoring terminal 400 to access the in-store communication network 7 by wireless communication. As the access point 6, for example, a well-known communication device that performs wireless communication conforming to IEEE 802.11 standard can be used. The access point 6 is installed in the store so that the user terminal 300 can wirelessly communicate from anywhere in the store. Depending on the store scale, a plurality of access points 6 may be disposed in one store system 100.

As the in-store communication network 7, the Internet, VPN, LAN, public communication network, mobile communication network, and the like can be used alone or in combination as appropriate. However, typically, the in-store communication network 7 is a LAN.

In a store where the store system 100 is installed, a two-dimensional code TCA for check-in is posted near the entrance, and a two-dimensional code TCB for checkout is posted near the exit. The two-dimensional code TCA represents check-in data for check-in. The two-dimensional code TCB represents checkout data for checkout. Check-in data and checkout data differ from store to store. Therefore, if it is necessary to distinguish between the two-dimensional codes TCA and TCB for store A and the two-dimensional codes TCA and TCB for store B, the two-dimensional codes for store A are referred to as two-dimensional codes TCAA and TCBA, and the two-dimensional codes for store B are referred to as two-dimensional codes TCAB and TCBB.

The check-in data includes information indicating various settings for operating smartphone or the like owned by a customer as a user terminal 300. The checkout data includes various information for terminating the operation as the user terminal 300.

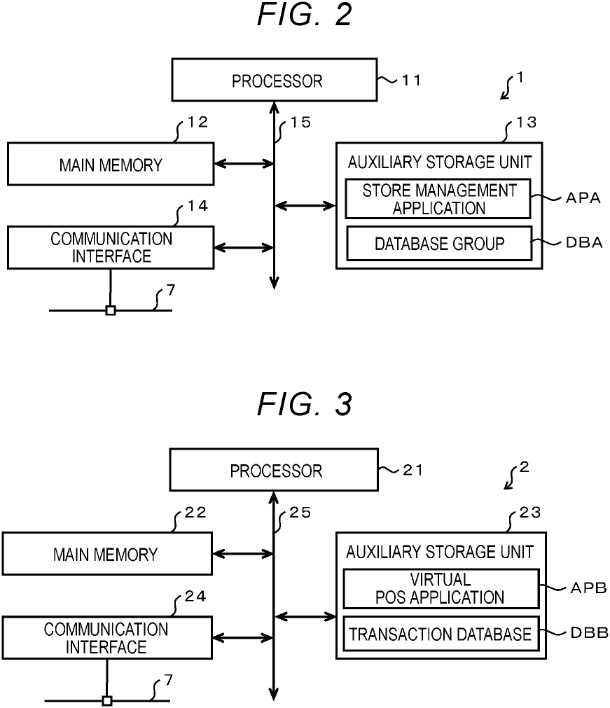

FIG. 2 is a hardware block diagram of the store server 1.

The store server 1 includes a processor 11, a main memory 12, an auxiliary storage unit 13, a communication interface 14, and a transmission line 15. The processor 11, the main memory 12, the auxiliary storage unit 13, and the communication interface 14 can communicate with each other via the transmission line 15.

The processor 11 executes information processing for performing various functions as the store server 1 according to an information processing program such as an operating system and an application program. The processor 11 is, for example, a central processing unit (CPU).

The main memory 12 includes a non-volatile memory area and a volatile memory area. The main memory 12 stores the above information processing program in the non-volatile memory area. The non-volatile or volatile memory area of the main memory 12 may store data necessary for the processor 11 to execute information processing. The volatile memory area of the main memory 12 is used as a work area where data is appropriately rewritten by the processor 11. The non-volatile memory area is, for example, a read only memory (ROM). The volatile memory area is, for example, a random access memory (RAM).

The auxiliary storage unit 13 is, for example, a storage unit such as an electric erasable programmable read-only memory (EEPROM), a hard disk drive (HDD), or a solid state drive (SSD). The auxiliary storage unit 13 stores data used for the processor 11 to perform various processes, data generated by the processes of the processor 11, and the like. The auxiliary storage unit 13 may store the above information processing program.

The communication interface 14 performs data communication with each unit connected to the in-store communication network 7 according to a predetermined communication protocol. As the communication interface 14, for example, a well-known communication device for LAN can be applied.

The transmission line 15 includes an address bus, a data bus, a control signal line, and the like, through which data and control signals are exchanged between the connected parts.

The auxiliary storage unit 13 stores a store management application APA, which is one of the information processing programs. The store management application APA is an application program that describes information processing for implementing the function as the store server 1. The store management application APA may be a separate one created according to the store management policy for each store or for each business operator who operates the store. For example, if the sales data management method is different between the store A and the store B, the store management application APA used in the store system 100-A performs the information processing for the management of the sales data adapted to the method of managing the sales data in the store A, and the store management application APA used in the store system 100-B performs the information processing for the management of the sales data adapted to the method of managing the sales data in the store B.

A part of the storage area of the auxiliary storage unit 13 is used as a database group DBA. The database group DBA includes a plurality of databases for various types of information management. One of the databases included in the database group DBA is a commodity database for managing commodities sold in the store. The commodity database is a collection of data records associated with a commodity to be managed. The data record of the commodity database contains data related to the associated commodity, such as a commodity code, unit price, commodity name, and the like. The commodity code is an identification code defined for identifying a commodity for each stock keeping unit (SKU), and for example, a Japanese article number (JAN) code is used. The commodity name is a name to distinguish the commodity. The unit price is a price of the commodity.

One of the databases included in the database group DBA is a user database for managing store users. The user database is a collection of data records associated with customers registered as users. The data record of the user database contains data related to the associated customer, such as a user code, attribute information for specifying the user, and the like. The user code is a unique identification code defined for each customer to individually identify the user. The attribute information may include a name, gender, age, address, telephone number, and the like. In addition, the data record of the user database may include payment information declared by the user. The payment information is a credit card number, a code payment ID (identifier), or the like. If a plurality of payment methods can be selected, the payment information may include a payment method code for identifying each payment method. In the case of a store that provides a point service (e.g., a customer loyalty program), the ID for the point service, the number of points earned, and the like may be included in the payment information.

In addition, the database group DBA may include various databases managed by the POS server in the existing POS system. The type of database that the database group DBA includes or the type of data included in the database and the structure thereof may be determined for each store.

FIG. 3 is a hardware block diagram of the virtual POS server 2.

The virtual POS server 2 includes a processor 21, a main memory 22, an auxiliary storage unit 23, a communication interface 24, and a transmission line 25. The processor 21, the main memory 22, the auxiliary storage unit 23, and the communication interface 24 can communicate with each other via the transmission line 25. Since the outline of the functions of the processor 21, the main memory 22, the auxiliary storage unit 23, the communication interface 24, and the transmission line 25 is the same as that of the processor 11, the main memory 12, the auxiliary storage unit 13, the communication interface 14, and the transmission line 15, the description thereof will be omitted.

However, the auxiliary storage unit 23 stores a virtual POS application APB instead of the store management application APA. The virtual POS application APB is an application program to perform functions as the virtual POS server 2. The virtual POS application APB may be a separate one created according to the store management policy for each store or for each business operator who operates the store. For example, if the store A provides a discount service that is not provided in the store B, the virtual POS application APB used in the store system 100-A performs information processing for the discount service, and the virtual POS application APB used in the store system 100-B does not perform the information processing for the discount service.

A part of the storage area of the auxiliary storage unit 23 can be used to store a transaction database DBB instead of the database group DBA. The transaction database DBB is a collection of data records associated with a transaction with a customer who is buying around in the store. The data record of the transaction database DBB includes a transaction code and commodity data related to a commodity registered as a purchased commodity. The transaction code is a unique identification code set for each transaction to identify each transaction. The commodity data represents a commodity code, a commodity name, a price, a quantity, and the like. The structure of the transaction database DBB may vary depending on a store management policy for each store or each business operator who operates the store.

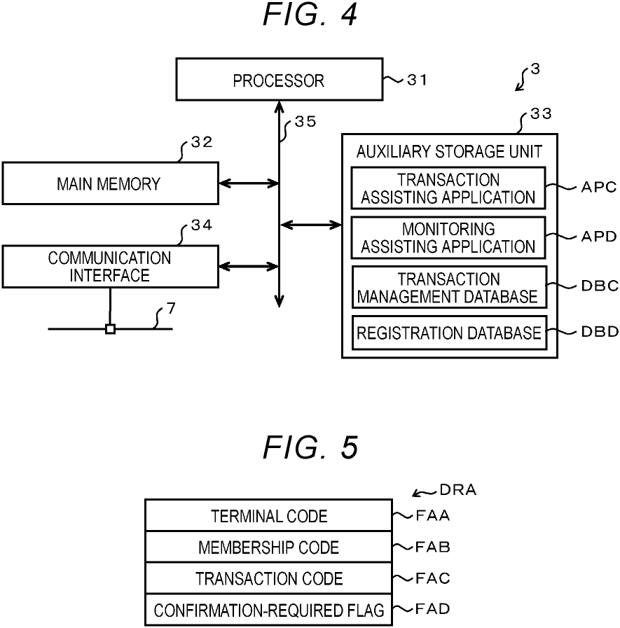

FIG. 4 is a hardware block diagram of the mobile controller 3.

The mobile controller 3 includes a processor 31, a main memory 32, an auxiliary storage unit 33, a communication interface 34, and a transmission line 35. The processor 31, the main memory 32, the auxiliary storage unit 33, and the communication interface 34 can communicate with each other via the transmission line 35. Since the outline of the functions of the processor 31, the main memory 32, the auxiliary storage unit 33, the communication interface 34, and the transmission line 35 is the same as that of the processor 11, the main memory 12, the auxiliary storage unit 13, the communication interface 14, and the transmission line 15, the description thereof will be omitted.

However, the auxiliary storage unit 33 stores a transaction assisting application APC and a monitoring assisting application APD instead of the store management application APA. The transaction assisting application APC is an application program to perform information processing described later for assisting the processes related to transactions. The monitoring assisting application APD is an application program to perform information processing described later for assisting monitoring, for example, an operating state of the user terminal 300 by a clerk. The transaction assisting application APC and the monitoring assisting application APD can be substantially the same for each store system 100. However, various settings for the information processing based on the transaction assisting application APC and the monitoring assisting application APD may be customized for each store system 100. However, in some examples, the transaction assisting application APC and the monitoring assisting application APD may be integrated as a single application program.

A part of the storage area of the auxiliary storage unit 33 can be used to store a transaction management database DBC and a registration database DBD instead of the database group DBA. The structures of the transaction management database DBC and the registration database DBD can be substantially the same for each store system 100.

FIG. 5 is a schematic diagram showing a data structure of a data record DRA included in the transaction management database DBC.

The transaction management database DBC is a collection of data records DRA associated with a user terminal 300 used by a customer in the store. Therefore, if there is only one customer in the store, the transaction management database DBC includes one data record DRA. If no customer exists in the store, the transaction management database DBC does not include any data record DRA. The data record DRA includes the fields FAA, FAB, FAC, and FAD.

A terminal code for identifying the associated user terminal 300 from another user terminal 300 is set in the field FAA. As the terminal code, for example, a unique identification code set for each communication terminal can be used to identify each communication terminal used as the user terminal 300. Alternatively, as the terminal code, for example, an identification code set for the smartphone POS application described later when installing the smartphone POS application on the user terminal 300 can be used. A membership code for identifying a customer using the associated user terminal 300 from another customer is set in the field FAB. The transaction code of the transaction performed using the associated user terminal 300 is set in the field FAC. A confirmation-required flag for identifying whether a confirmation-required commodity is included in the commodities registered as purchased commodities using the associated user terminal 300 is set in the field FAD. In the present embodiment, the confirmation-required flag indicates that a confirmation-required commodity is included if the value is “1”. The data record DRA may include another field in which data different from that in the fields FAA to FAC is set. In other words, the confirmation-required flag indicates whether a confirmation by a clerk is required.

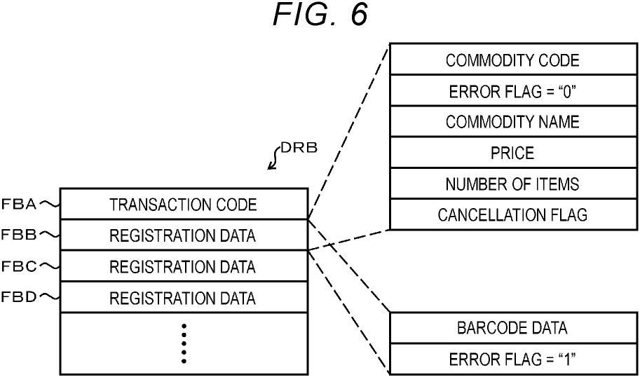

FIG. 6 is a schematic diagram showing a data structure of a data record DRB included in the registration database DBD.

The registration database DBD is a collection of data records DRB associated with transactions with customers who are buying around in the store. The data record DRB includes the fields FBA and FBB. The data record DRB may also include fields FBC, FBD...

The transaction code of the associated transaction is set in the field FBA. This transaction code is the same as the transaction code set in the field FAB of the data record DRA associated with the user terminal 300 used in the associated transaction. The field FBB is registration data regarding a temporarily registered commodity in the associated transaction. The registration data will be described later.

The data record DRB includes the field FBC and subsequent fields if two or more purchased commodities are temporarily registered for the associated transaction. Then, the same registration data as the field FAB is set in the field FBC and the subsequent fields.

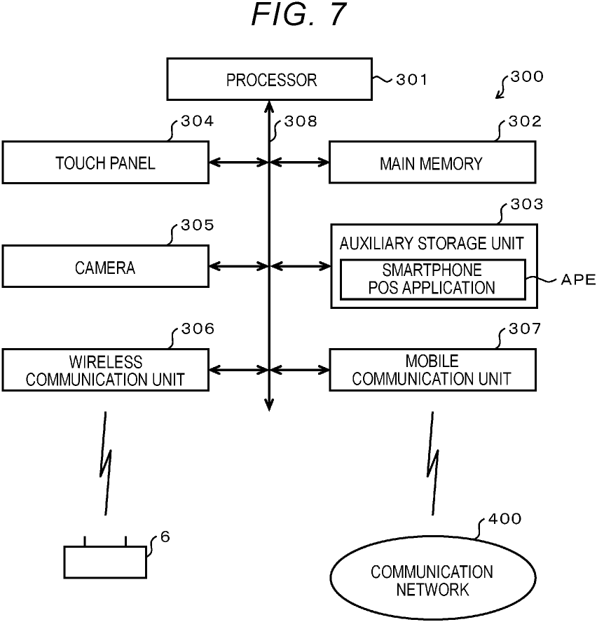

FIG. 7 is a hardware block diagram of the user terminal 300.

The user terminal 300 includes a processor 301, a main memory 302, an auxiliary storage unit 303, a touch panel 304, a camera 305, a wireless communication unit 306, a mobile communication unit 307, a transmission line 308, and the like. The processor 301 can communicate with the main memory 302, the auxiliary storage unit 303, the touch panel 304, the camera 305, and the mobile communication unit 307 via the transmission line 308. Since the outline of the functions of the processor 301, the main memory 302, the auxiliary storage unit 303, and the transmission line 308 is the same as that of the processor 11, the main memory 12, the auxiliary storage unit 13, and the transmission line 15, the description thereof will be omitted.

The touch panel 304 functions as an input device and a display device of the user terminal 300.

The camera 305 includes an optical system and an image sensor, and the image sensor generates image data representing an image in the field of view formed by the optical system.

The wireless communication unit 306 exchanges data with the access point 6 by wireless communication conforming to the wireless communication protocol. As the wireless communication unit 306, for example, a well-known communication device compliant with IEEE 802.11 standard can be used.

The mobile communication unit 307 is an interface for data communication via the communication network 500. As the mobile communication unit 307, for example, a well-known communication device for performing data communication via a mobile communication network can be used.

The auxiliary storage unit 303 stores a smartphone POS application APE, which is one of the information processing programs. The smartphone POS application APE is an application program to perform information processing described later for causing the user terminal 300 to function as a user interface of the store system 100. The smartphone POS application APE can be used on a plurality of user terminals 300.

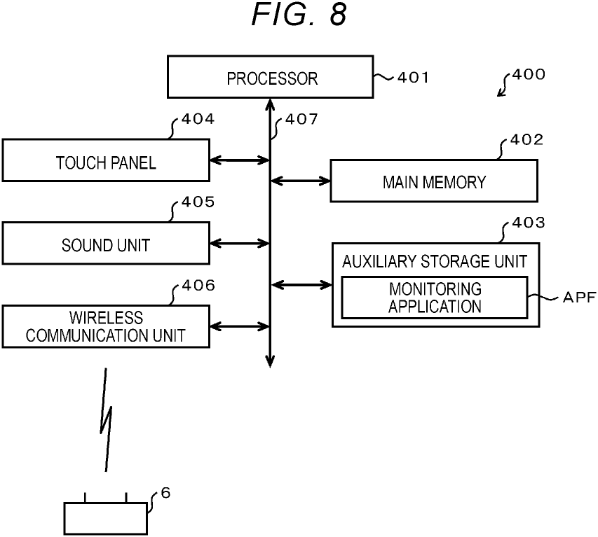

FIG. 8 is a hardware block diagram of the monitoring terminal 400.

The monitoring terminal 400 includes a processor 401, a main memory 402, an auxiliary storage unit 403, a touch panel 404, a sound unit 405, a wireless communication unit 406, a transmission line 407, and the like. The processor 401 can communicate with the main memory 402, the auxiliary storage unit 403, the touch panel 404, the sound unit 405, and the wireless communication unit 406 via the transmission line 407. Since the outline of the functions of the processor 401, the main memory 402, the auxiliary storage unit 403, and the transmission line 407 is the same as that of the processor 11, the main memory 12, the auxiliary storage unit 13, and the transmission line 15, the description thereof will be omitted.

The touch panel 404 functions as an input device and a display device of the monitoring terminal 400.

The sound unit 405 synthesizes and outputs an arbitrary sound. The sound unit 405 may be capable of synthesizing only a monotonous sound such as a buzzer sound or may be capable of synthesizing a melody or a voice. For example, the sound unit 405 is a speaker.

The wireless communication unit 406 exchanges data with the access point 6 by wireless communication conforming to the wireless communication protocol. As the wireless communication unit 406, for example, a well-known communication device compliant with IEEE 802.11 standard can be used.

The auxiliary storage unit 403 stores a monitoring application APF, which is one of the information processing programs. The monitoring application APF is an application program and causes the monitoring terminal 400 to function as a user interface device for assisting a store clerk in monitoring the system. A web browser may be used as the monitoring application APF.

As the hardware of the store server 1, the virtual POS server 2, or the mobile controller 3, for example, a general-purpose server device can be used. Then, the transfer of the store server 1, the virtual POS server 2, or the mobile controller 3 is generally performed in a state where the store management application APA, the virtual POS application APB, or the transaction assisting application APC, and the monitoring assisting application APD are stored in the auxiliary storage units 13, 23, or 33, respectively, and the database group DBA, the transaction database DBB, the transaction management database DBC, and the registration database DBD are not stored. However, the hardware in the state where the store management application APA, the virtual POS application APB, or the transaction assisting application APC is not stored in the auxiliary storage unit 13, 23, or 33, or another version of the same type of application program is stored in the auxiliary storage unit 13, 23, or 33 may be transferred separately from the store management application APA, the virtual POS application APB, or the transaction assisting application APC and the monitoring assisting application APD. Then, the store server 1, the virtual POS server 2, or the mobile controller 3 may be configured by writing the store management application APA, the virtual POS application APB, or the transaction assisting application APC and the monitoring assisting application APD in the auxiliary storage unit 13, 23, or 33 in response to the operation of any operator. The transfer of the store management application APA, the virtual POS application APB, or the transaction assisting application APC and the monitoring assisting application APD can be performed by being recorded on a removable recording medium such as a magnetic disk, magneto-optical disk, optical disk, semiconductor memory, or by the communication via the network. The transaction database DBB, or the transaction management database DBC, and the registration database DBD is configured in the auxiliary storage unit 13, 23, or 33 by the processor 11, 21, or 31 executing information processing based on the store management application APA, the virtual POS application APB, or the transaction assisting application APC. At least a part of the store management application APA and the database included in the database group DBA may be stored in the main memory 12. At least a part of the virtual POS application APB and the transaction database DBB may be stored in the main memory 22. At least a part of the transaction assisting application APC, the monitoring assisting application APD, the transaction management database DBC, and the registration database DBD may be stored in the main memory 32.

Next, the operation of the transaction processing system configured as described above will be described. The contents of the various processes described below are examples, and a change in the order of some processes, omission of some processes, or addition of another process can be made as appropriate. For example, in the following description, in order to explain the characteristic operation of the present embodiment in an easy-to-understand manner, the description of some processes is omitted. For example, if some error occurs, processing for dealing with the error may be performed, but the description about a part of such processing is omitted.

The service provided to the customer by the operation of the transaction processing system described below is referred to as a smartphone POS service.

The user terminal 300 exchanges data with the store system 100 to use the smartphone POS service, and whether to use wireless communication with the access point 6 or wireless communication with the communication network 500 for communication for that purpose is determined by the state of the flag contained in the check-in data. However, in the following, for the sake of simplification of the description, a case where only wireless communication with the access point 6 is used will be described. In addition, which mode is used for data transmission from the virtual POS server 2 to the checkout machine 5 to perform checkout in the checkout machine 5 between the mode in which the data transmission is requested from the checkout machine 5 to the mobile controller 3, and the mode in which data is transmitted from the mobile controller 3 to the checkout machine 5 with no request from the checkout machine 5 is determined by the state of the flag included in the check-in data. However, in the following, for the sake of simplification of the description, only the mode of requesting data transmission from the checkout machine 5 to the mobile controller 3 will be used.

In order to use the smartphone POS service, the customer installs the transaction assisting application APC on his/her own smartphone or the like and makes the smartphone available as the user terminal 300. Alternatively, the customer rents a user terminal 300 configured by installing the transaction assisting application APC on a tablet terminal or the like at the store. Then, the customer carries the user terminal 300 in the state where the information processing started based on the transaction assisting application APC and enters any store using the store system 100.

Now, in the user terminal 300, the processor 301 executes information processing (hereinafter referred to as user interface processing) based on the smartphone POS application.

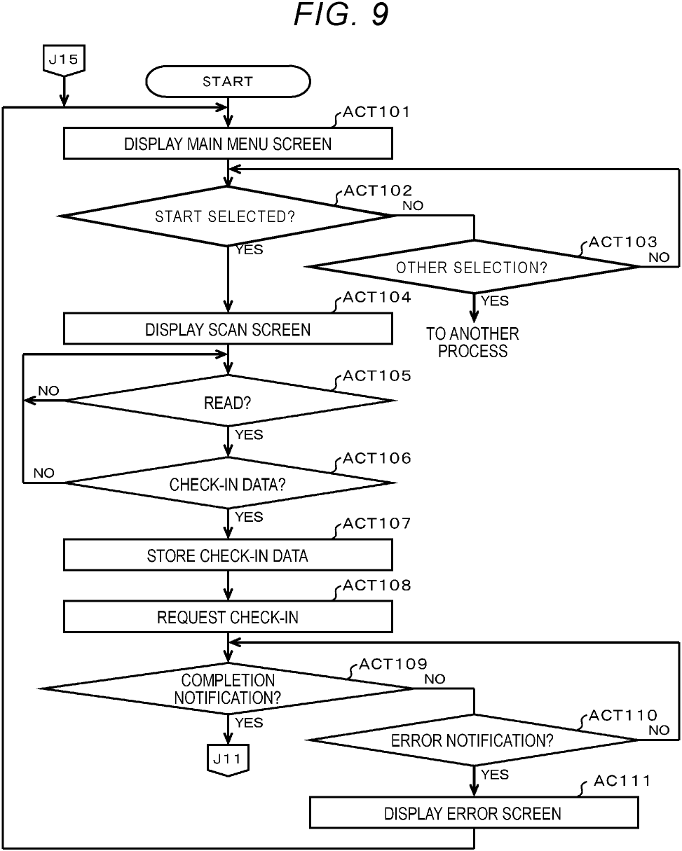

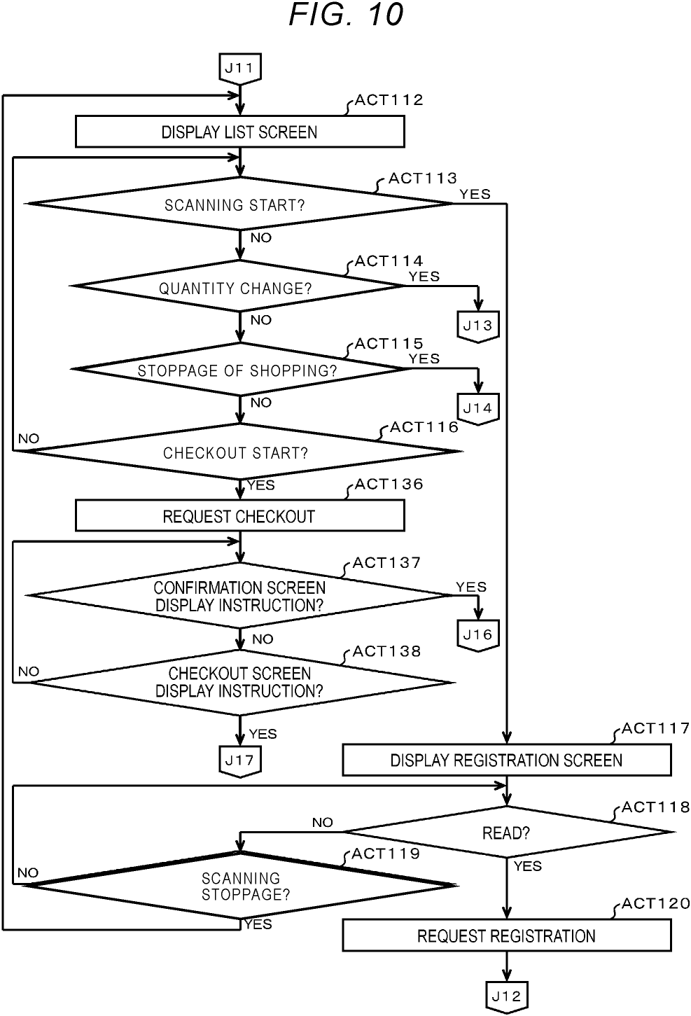

FIGS. 9, 10, 11, 12, and 13 are flowcharts of the user interface processing by the processor 301.

First, as ACT 101 shown in FIG. 9, the processor 301 controls the touch panel 304 to display a main menu screen. The main menu screen is a screen for receiving the designation of any of several processes to be performed based on the transaction assisting application APC. On the main menu screen, a plurality of graphical user interface (GUI) elements including a GUI element for designating the start of shopping are arranged. The GUI element is, for example, a software key.

As ACT 102, the processor 301 checks whether the start of shopping is selected. Then, if the corresponding selection cannot be confirmed, the processor 301 determines NO and proceeds to ACT 103.

As ACT 103, the processor 301 checks whether a selection other than the start of shopping was made. Then, if the corresponding selection cannot be confirmed, the processor 301 determines NO and returns to ACT 102.

Thus, the processor 301 waits for some selection to be made on the main menu screen, as ACT 102 and ACT 103. Then, if a selection other than the start of shopping is made, the processor 301 determines YES in ACT 103 and proceeds to the selected processing. The description of the processing of the processor 301, in this case, will be omitted.

If the customer enters the store and starts shopping, the customer performs a predetermined operation for selecting the start of shopping on the main menu screen.

If the operation for selecting the start of shopping is detected on the touch panel 304, the processor 301 determines YES on ACT 102 and proceeds to ACT 104.

As ACT 104, the processor 301 controls the touch panel 304 to display a scan screen for check-in. The check-in scan screen is a screen that prompts the customer to operate the camera 305 to read a check-in two-dimensional code TCA. For example, the processor 301 activates the camera 305 and generates the scan screen by overlapping an image obtained by the camera 305 with a message prompting the customer to operate the camera 305 to read the two-dimensional code TCA and a line indicating the position where the two-dimensional code TCA should be held.

If the scan screen is displayed on the touch panel 304, the customer points the camera 305 at a two-dimensional code TCA so that the two-dimensional code TCA posted near the entrance of the store is reflected on the scan screen.

As ACT 105, the processor 301 waits for the two-dimensional code to be read. At this time, the processor 301 repeatedly analyzes the image obtained by the camera 305 and attempts to read the two-dimensional code. The reading of the two-dimensional code may be performed as a process based on the smartphone POS application APE or may be performed as a process based on another application program for reading the two-dimensional code. Then, if the two-dimensional code is read, the processor 301 determines YES and proceeds to ACT 106.

As ACT 106, the processor 301 checks whether the data represented by the read two-dimensional code is check-in data. Then, the processor 301 determines NO if the data is not check-in data, and returns to ACT 105. At this time, the processor 301 may control the touch panel 304 to display a screen notifying the customer that an erroneous two-dimensional code was read.

If it can be confirmed that the data represented by the read two-dimensional code is check-in data, the processor 301 determines YES in ACT 106 and proceeds to ACT 107.

As ACT 107, the processor 301 stores the read check-in data in the main memory 302 or the auxiliary storage unit 303.

As ACT 108, the processor 301 requests the mobile controller 3 to check-in. Specifically, the processor 301 establishes wireless communication between the wireless communication unit 306 and the access point 6 based on the data represented by the check-in data. For example, if the camera 305 is pointed at the two-dimensional code TCAA by the customer in the store A, the processor 301 establishes wireless communication with the access point 6 provided in the store system 100-A based on the check-in data represented by the two-dimensional code TCAA. Then, the processor 301 controls the wireless communication unit 306 to transmit the request data for requesting the check-in to the mobile controller 3 via wireless communication with the access point 6. If wireless communication with the access point 6 provided in the store system 100-A is established as described above, the request data is transmitted to the mobile controller 3 provided in the store system 100-A via the access point 6 and the in-store communication network 7 provided in the store system 100-A. The processor 301 includes identification data for identifying the request for check-in and a terminal code in the request data for requesting check-in. If the customer is a registered user of the smartphone POS service and has a membership code, the processor 301 also includes the membership code in the request data. The membership code is stored, for example, in the auxiliary storage unit 303 of the user terminal 300. The processor 301 may include other data such as data for authenticating a customer in the request data.

Various requests from the user terminal 300 to the mobile controller 3 described below are performed by transmitting request data including identification data for identifying the reason for the request from the user terminal 300 to the mobile controller 3 via the access point 6 and the in-store communication network 7 in the same manner as described above.

In the mobile controller 3, if the request data for requesting check-in is received by the communication interface 34, the processor 31 starts information processing for assisting the processes related to the transaction with the customer who is trying to check-in (hereinafter referred to as transaction assisting processing).

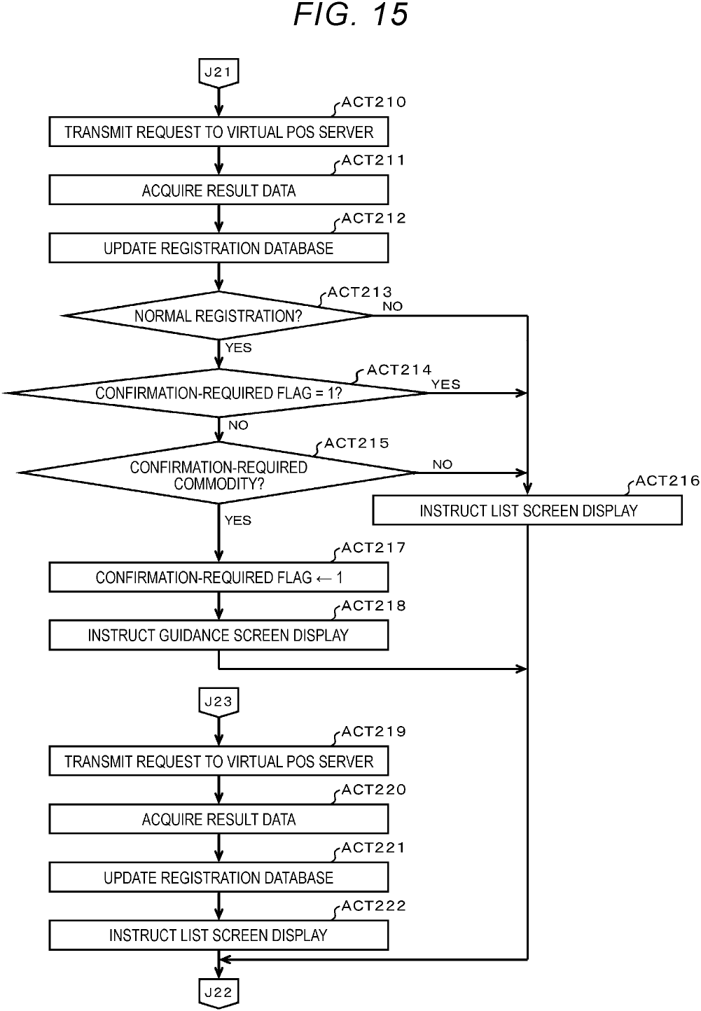

FIGS. 14, 15, 16, and 17 are flowcharts of transaction assisting processing by the processor 31.

The processor 31 starts the transaction assisting processing every time a request data for requesting check-in is received by the communication interface 34. If the transaction assisting processing started based on another request is already executed, new transaction assisting processing is started in parallel. That is, the processor 31 may execute a plurality of transaction assisting processing in parallel for each of the plurality of user terminals 300. In the following, if the term “user terminal 300” is simply used, it refers to the user terminal 300 that is the target of the transaction assisting processing of the processor 31.

As ACT 201 of FIG. 14, the processor 31 performs a check-in process. The processor 31 requests, for example, the virtual POS server 2 to start a transaction and is notified of a transaction code. Then, the processor 31 adds a new data record DRA in which the terminal code included in the request data is set in the field FAA to the transaction management database DBC. If the request data includes a membership code, the processor 31 sets the membership code in the field FAB of the new data record DRA. The processor 31 sets the above-notified transaction code in the field FAC of the new data record DRA. The processor 31 sets “0” to a confirmation-required flag in the field FAD of the new data record DRA. As a result, the management of transactions performed using the user terminal 300 requesting check-in is started.

In the virtual POS server 2, if the mobile controller 3 requested the start of the transaction, the processor 21 determines a transaction code according to a predetermined rule and starts the registration process of purchased commodities associated with the transaction code. The processor 21 notifies the mobile controller 3 of the determined transaction code.

As ACT 202, the processor 31 checks whether the check-in process was completed normally. Then, if the check-in process could not be completed normally due to some abnormality, the processor 31 determines NO and proceeds to ACT 203.

As ACT 203, the processor 31 notifies the user terminal 300 of an error. For example, the processor 31 controls the communication interface 34 to transmit notification data for error notification to the user terminal 300 via the in-store communication network 7 and the access point 6. The processor 31 includes identification data for identifying that it is an error notification in the notification data. The processor 31 may include an error code indicating the cause of the error in the notification data.

Various notifications from the mobile controller 3 to the user terminal 300 described below are performed by transmitting notification data including identification data for identifying a reason for the notification from the mobile controller 3 to the user terminal 300 via the in-store communication network 7 and the access point 6 in the same manner as described above.

On the other hand, if the check-in process was completed normally, the processor 31 determines YES in ACT 202 and proceeds to ACT 204.

As ACT 204, the processor 31 notifies the user terminal 300 of the completion of check-in. For example, the processor 31 controls the communication interface 34 to transmit notification data for notifying the completion of check-in to the user terminal 300 via the in-store communication network 7 and the access point 6. The processor 31 includes identification data for identifying that it is a check-in completion notification in the notification data.

In the user terminal 300, the processor 301 proceeds to ACT 109 after requesting the check-in at ACT 108 in FIG. 9.

As ACT 109, the processor 301 checks whether the check-in completion was notified. Then, if the notification cannot be confirmed, the processor 301 determines NO and proceeds to ACT 110.

As ACT 110, the processor 301 checks whether a check-in error was notified. Then, if the notification cannot be confirmed, the processor 301 determines NO and returns to ACT 109.

Thus, the processor 301 waits for the completion of check-in or an error to be notified, as ACT 109 and ACT 110. Then, if the notification data for an error notification is received by the wireless communication unit 306, the processor 301 determines YES in ACT 110 and proceeds to ACT 111.

As ACT 111, the processor 301 controls the touch panel 304 to display an error screen. The error screen notifies the customer that check-in is not possible. If the processor 301 is instructed to close the error screen by, for example, by an operation of the GUI element displayed in the error screen, the processor 301 returns to ACT 101.

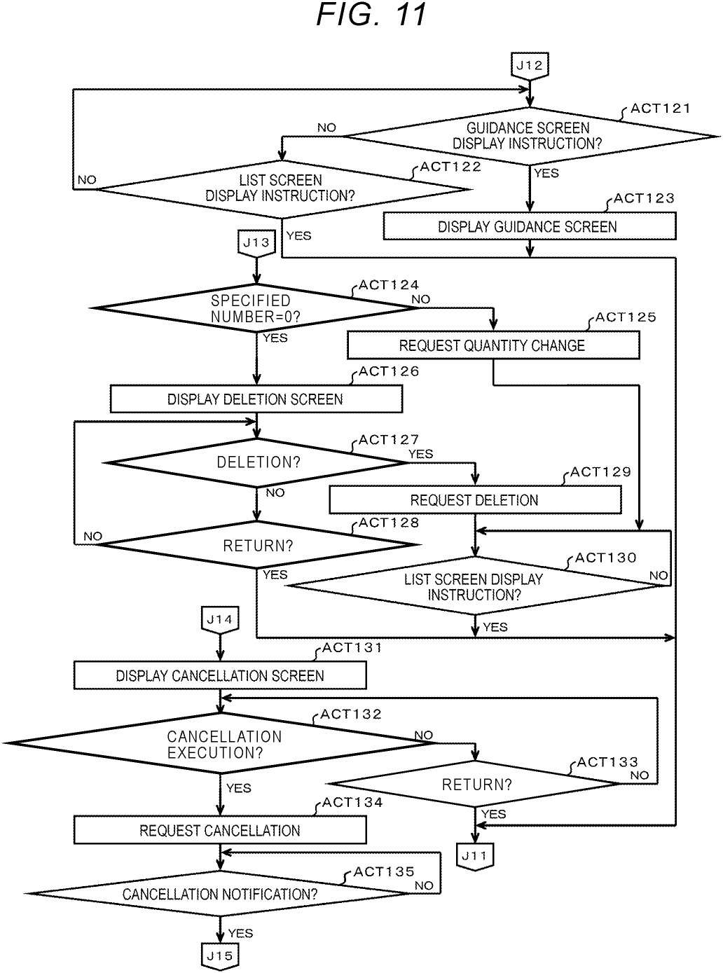

On the other hand, if the notification data for the check-in completion notification is received by the wireless communication unit 306, the processor 301 determines YES in ACT 109 and proceeds to ACT 112 in FIG. 10.

As ACT 112, the processor 301 controls the touch panel 304 to display the list screen. The list screen is a screen showing a list of registered purchased commodities.

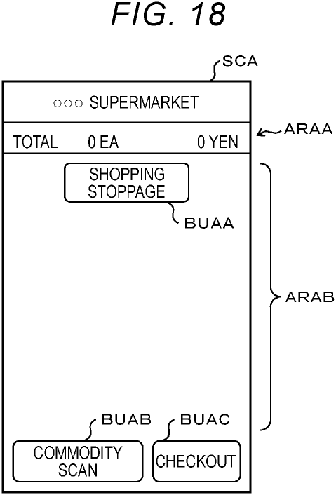

FIG. 18 is a diagram showing an example of a list screen SCA.

The list screen SCA includes display areas ARAA and ARAB, and buttons BUAA, BUAB, and BUAC. The display area ARAA shows the total quantity of purchased commodities and the total price of the purchased commodities. The display area ARAB shows a list of purchased commodities. The button BUAA is a software key for the customer to declare to cancel all purchased commodities and stop shopping. The button BUAB is a software key for the customer to declare to start the scan of a commodity to be registered as a purchased commodity. The button BUAC is a software key for the customer to declare to start the checkout.

FIG. 18 shows the list screen SCA in a state where any purchased commodity is not registered yet. Therefore, both the total quantity and the total price represent “0” in the display area ARAA, and nothing is shown in the display area ARAB.

As ACT 113 in FIG. 10, the processor 301 checks whether the start of scanning the commodity is selected. Then, if the corresponding selection cannot be confirmed, the processor 301 determines NO and proceeds to ACT 114.

As ACT 114, the processor 301 checks whether the quantity change is selected. Then, if the corresponding selection cannot be confirmed, the processor 301 determines NO and proceeds to ACT 115.

As ACT 115, the processor 301 checks whether the stoppage of shopping is selected. Then, if the corresponding selection cannot be confirmed, the processor 301 determines NO and proceeds to ACT 116.

As ACT 116, the processor 301 checks whether the start of checkout is selected. Then, if the corresponding selection cannot be confirmed, the processor 301 determines NO and returns to ACT 113.

Thus, the processor 301 waits for any of the scan start, quantity change, stoppage, or checkout start to be selected, as ACT 113 to ACT 116.

If the customer registers a commodity as a purchased commodity, the customer selects the start of scanning by a predetermined operation such as touching the button BUAB on the list screen SCA. In response to this, the processor 301 determines YES in ACT 113 and proceeds to ACT 117.

As ACT 117, the processor 301 controls the touch panel 304 to display the registration screen on the touch panel 304. The registration screen prompts the customer to operate the camera 305 to read a barcode representing the commodity code of a commodity to be registered as a purchased commodity.

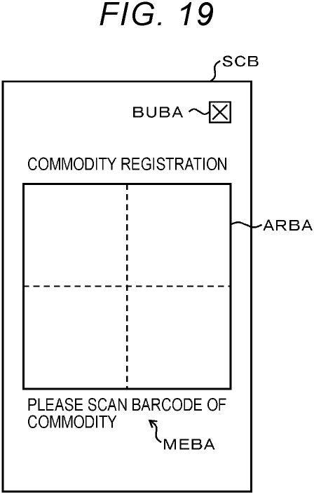

FIG. 19 is a diagram showing an example of the registration screen SCB.

The registration screen SCB includes a display area ARBA, a message MEBA, and a button BUBA. The display area ARBA displays an image obtained by the camera 305. The message MEBA is a text message that prompts the customer to read the barcode of a commodity. The button BUBA is a software key for the customer to declare to stop scanning the commodity code.

For example, the processor 301 activates the camera 305 and generates the registration screen SCB by overlapping the image obtained by the camera 305 with the lines showing the range of the display area ARBA and the image showing the message MEBA and the button BUBA.

As ACT 118 in FIG. 10, the processor 301 checks whether any barcode was read. At this time, the processor 301 analyzes the image obtained by the camera 305 and attempts to read a barcode. The barcode reading may be performed as a process based on the smartphone POS application APE or may be performed as a process based on another application program for reading the barcode. Then, if the barcode cannot be read, the processor 301 determines NO and proceeds to ACT 119.

As ACT 119, the processor 301 checks whether the stoppage of scanning is selected. Then, if the corresponding selection cannot be confirmed, the processor 301 determines NO and returns to ACT 118.

Thus, the processor 301 waits for a barcode to be read or for the stoppage of scanning to be selected, as ACT 118 and ACT 119.

If the customer desires to return to the list screen without performing this scanning, the stoppage of scanning is selected by a predetermined operation such as touching the button BUBA. In response to this, the processor 301 determines YES in ACT 119 and returns to ACT 112.

If the registration screen is displayed on the touch panel 304, the customer points the camera 305 at the commodity so that the barcode displayed on a commodity to be registered as a purchased commodity is reflected in the display area ARBA. In response to this, the processor 301 determines YES in ACT 118 and proceeds to ACT 120.

As ACT 120, the processor 301 requests the mobile controller 3 to register the commodity. The request data generated by the processor 301 includes data represented by the read barcode (hereinafter referred to as barcode data).

Now, in the mobile controller 3, the processor 31 proceeds to ACT 205 after notifying the completion of check-in in ACT 204 in FIG. 14.

As ACT 205, the processor 31 checks whether registration is requested. Then, if the corresponding request cannot be confirmed, the processor 31 determines NO and proceeds to ACT 206.

As ACT 206, the processor 301 checks whether a quantity change is requested. Then, if the corresponding request cannot be confirmed, the processor 31 determines NO and proceeds to ACT 207.

As ACT 207, the processor 31 checks whether a deletion of a purchased commodity is requested. Then, if the corresponding request cannot be confirmed, the processor 31 determines NO and proceeds to ACT 208.

As ACT 208, the processor 31 checks whether a cancellation of a purchased commodity is requested. Then, if the corresponding request cannot be confirmed, the processor 31 determines NO and proceeds to ACT 209.

As ACT 209, the processor 31 checks whether checkout is requested. Then, if the corresponding request cannot be confirmed, the processor 31 determines NO and returns to ACT 205.

Thus, the processor 31 waits for any of the registration, quantity change, deletion, cancellation, and checkout to be requested, as ACT 205 to ACT 209. Then, if the registration is requested from the user terminal 300 as described above, the processor 31 determines YES in ACT 205 and proceeds to ACT 210 in FIG. 15.

As ACT 210, the processor 31 controls the communication interface 34 to transmit the registration request to the virtual POS server 2 with the notification of the transaction code of the transaction to be processed. At this time, the processor 31 may control the communication interface 34 to transmit the request data sent from the user terminal 300 to the virtual POS server 2 as it is or may control the communication interface 34 to transmit the request data converted by some processing to the virtual POS server 2. However, the processor 31 notifies the virtual POS server 2 of the barcode data included in the request data sent from the user terminal 300.

In the virtual POS server 2, the processor 21 considers the barcode data included in the request data sent from the mobile controller 3 as the one read by a barcode scanner of a conventional POS terminal, and attempts to register the purchased commodity by the same processing as the conventional POS terminal. However, the commodity may display a barcode different from the commodity code used by the virtual POS server 2, and therefore, the barcode data included in the request data may not represent the commodity code used by the virtual POS server 2. In such a case, the processor 21 cannot register the purchased commodity and an error occurs. In this way, the processor 21 registers the purchased commodity based on the normal barcode reading. The processor 21 manages purchased commodities using the transaction database DBB.

The processor 21 controls the communication interface 24 to transmit result data representing the result of such processing to the mobile controller 3. If the purchased commodity is correctly registered, the processor 21 includes identification data for identifying that it is a notification of normal registration, and the commodity code, commodity name, and price of the registered commodity in the result data. In the case of an error, the processor 21 includes the identification data for identifying that it is a notification of an error, and the barcode data sent in the registration request in the result data.

In the mobile controller 3, the processor 31 proceeds to ACT 211 after transmitting the registration request in ACT 210.

As ACT 211, the processor 31 acquires the result data transmitted from the virtual POS server as described above. The processor 31 stores the acquired result data in the main memory 32 or the auxiliary storage unit 33.

As ACT 212, the processor 31 updates the registration database DBD based on the above result data. The registration database DBD is updated as follows, for example.

First case: If it is a notification of regular registration and the registration data including the notified commodity code is not included in the data record DRB associated with the transaction to be processed.

In such a case, the processor 31 adds a new field after the last field already existing in the data record DRB associated with the transaction to be processed and adds new registration data to the field. The processor 31 includes the notified commodity code, an error flag set to “0” indicating that it is not an error, the notified commodity name and price, the quantity set to “1”, and a cancellation flag set to “0” indicating that it was not canceled, in the new registration data. Thus, the registration data added in this first case has a structure as shown on the upper right side of FIG. 6.

Second case: If it is a notification of normal registration, and although the registration data including the notified commodity code is included in the data record DRB associated with the transaction to be processed, the cancellation flag of the registration data is “1” indicating that the commodity was canceled.

In such a case, the processor 31 processes in the same manner as in the first case described above.

Third case: If it is a notification of normal registration, the registration data including the notified commodity code is included in the data record DRB associated with the transaction to be processed, and the cancellation flag of the registration data is “0”.

In such a case, the processor 31 rewrites the value of the quantity included in the registration data including the notified commodity code and the cancellation flag set to “0” to one larger value.

Fourth case: If it is an error notification, the processor 31 adds a new field after the last field already existing in the data record DRB associated with the transaction to be processed and adds new registration data to the field. The processor 31 includes the notified barcode data and the error flag set to “1” indicating an error in the new registration data. Thus, the registration data added in this fourth case has a structure as shown in the lower right side of FIG. 6.

By being updated by the processor 31 in this way, the registration database DBD not only represents a list of purchased commodities registered in the virtual POS server 2 but also records an erroneous barcode reading.

The processor 31 stores the barcode data sent in the registration request in the main memory 32 or the auxiliary storage unit 33, and in the above-mentioned fourth case, the stored barcode data may be included in registration data. In such a case, the processor 21 in the virtual POS server 2 does not have to include the barcode data in the result data. The processor 31 may retrieve a commodity code from the stored barcode data and process the first case to the third case based on the commodity code. The commodity name and the price may be acquired by the processor 31 from the store server 1 or the like based on the commodity code.

As ACT 213, the processor 31 checks whether this registration was performed normally. Then, the processor 31 determines YES if it is a normal registration, and proceeds to ACT 214.

As ACT 214, the processor 31 checks whether the confirmation-required flag set in the field FAD is “1” for the data record DRA associated with the transaction to be processed in the transaction management database DBC. Then, if the confirmation-required flag is not “1”, the processor 31 determines NO and proceeds to ACT 215.

As ACT 215, the processor 31 checks whether the purchased commodity registered this time is a confirmation-required commodity. Then, the processor 31 determines NO if it is not a confirmation-required commodity, and proceeds to ACT 216. The processor 31 proceeds to ACT 216 even if it is determined NO in ACT 213 because the registration this time is an error, and if it is determined YES in ACT 214 because the confirmation-required flag is “1”.

As ACT 216, the processor 31 instructs the user terminal 300 to display a list screen. For example, the processor 31 controls the communication interface 34 to transmit instruction data including identification data for identifying that it is a list screen display instruction to the user terminal 300 via the in-store communication network 7 and the access point 6. The processor 31 includes the commodity code, commodity name, price, and quantity included in the data record DRB associated with the transaction to be processed in the registration database DBD in the instruction data. If the registration this time is an error, the processor 31 includes error data indicating that fact in the instruction data. After that, the processor 31 returns to the standby state of ACT 205 to ACT 209 in FIG. 14.

Various instructions from the mobile controller 3 to the user terminal 300 described below are performed by transmitting instruction data including identification data for identifying a reason for the instruction from the mobile controller 3 to the user terminal 300 via the in-store communication network 7 and the access point 6, as described above.

On the other hand, if it is determined YES in ACT 215 because it is a confirmation-required commodity, the processor 31 proceeds to ACT 217. That is, the processor 31 proceeds to ACT 217 if the normally registered commodity is a confirmation-required commodity and the confirmation-required flag is “0”.

As ACT 217, the processor 31 rewrites the confirmation-required flag set in the field FAD to “1” for the data record DRA associated with the transaction to be processed in the transaction management database DBC.

As ACT 218, the processor 31 instructs the user terminal 300 to display the guidance screen. The processor 31 includes a commodity code, commodity name, price, and quantity included in the data record DRB associated with the transaction to be processed in the registration database DBD in the instruction data for instructing the display of a guidance screen. After that, the processor 31 returns to the standby state of ACT 205 to ACT 209 in FIG. 14.

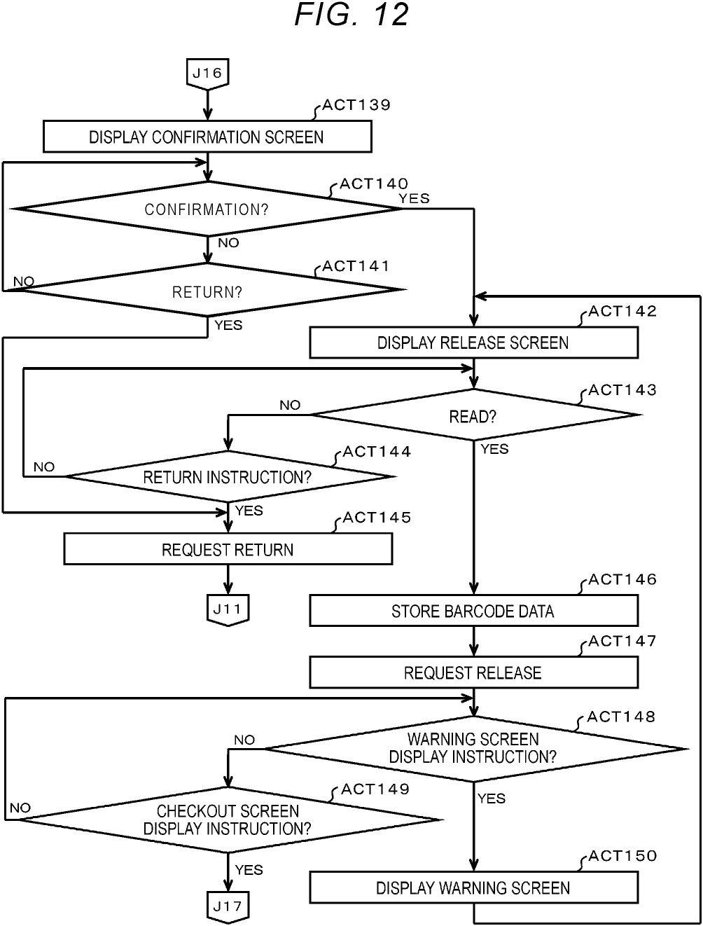

In the user terminal 300, the processor 301 proceeds to ACT 121 in FIG. 11 after requesting registration in ACT 120 in FIG. 10.

As ACT 121, the processor 301 checks whether the display of the guidance screen is instructed. Then, if the corresponding instruction cannot be confirmed, the processor 301 determines NO and proceeds to ACT 122.

As ACT 122, the processor 301 checks whether the display of the list screen is instructed. Then, if the corresponding instruction cannot be confirmed, the processor 301 determines NO and returns to ACT 121.

Thus, the processor 301 waits for the display instruction of the guidance screen or the list screen, as ACT 121 and ACT 122. Then, if the display of the list screen is instructed by the mobile controller 3 as described above, the processor 301 determines YES in ACT 122, returns to ACT 112 in FIG. 10, and displays the list screen SCA on the touch panel 304 again. At this time, the processor 301 uses the list screen SCA as a screen showing the commodity name, price, and quantity of the purchased commodities included in the instruction data.

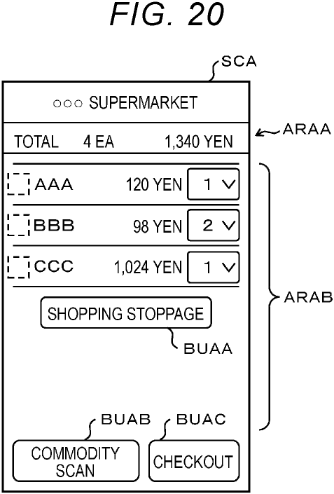

FIG. 20 is a diagram showing an example of the list screen SCA in a state where the purchased commodities were registered. The list screen SCA shown in FIG. 20 is an example of the case where one commodity having a commodity name of “AAA” and a price of 120 yen, two commodities having a commodity name of “BBB” and a price of 98 yen, and one commodity having a commodity name of “CCC” and a price of 1,024 yen were registered as the purchased commodities. None of these commodities are confirmation-required commodities. In the list screen SCA shown in FIG. 20, the display area ARAB shows the commodity names, prices, and quantities of these registered commodities. In the display area ARAA, “4” is indicated as the total quantity and “1,340” is indicated as the total price. The area surrounded by the broken line on the left side of the commodity name represents the area for displaying icons. The broken line indicating the area is not itself actually displayed on the list screen SCA.

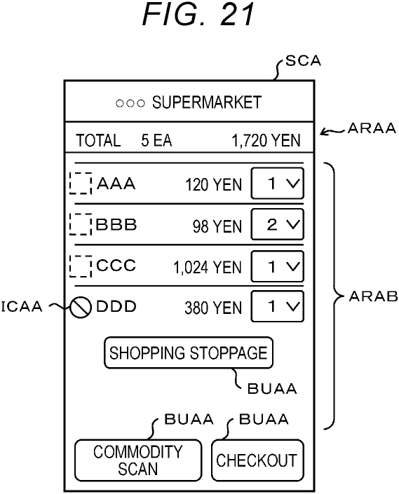

FIG. 21 is a diagram showing an example of the list screen SCA in a state where the purchased commodities were registered.

The list screen SCA shown in FIG. 21 is an example in which one commodity having a commodity name of “AAA” and a price of 120 yen, two commodities having a commodity name of “BBB” and a price of 98 yen, one commodity having a commodity name of “CCC” and a price of 1,024 yen, and one commodity having a commodity name of “DDD” and a price of 380 yen are registered as purchased commodities. The commodity having a commodity name of “DDD” is a confirmation-required commodity. In the list screen SCA shown in FIG. 21, the display area ARAB shows the commodity names, prices, and quantities of these registered commodities. In the display area ARAA, “5” is indicated as the total quantity and “1,720” is indicated as the total price. Next to the commodity name “DDD”, an icon ICAA indicating that the commodity is subject to an age restriction for the purchaser is displayed.

On the other hand, if the display of the guidance screen is instructed by the mobile controller 3 as described above, the processor 301 determines YES in ACT 121 in FIG. 11 and proceeds to ACT 123.

As ACT 123, the processor 301 controls the touch panel 304 to display the guidance screen. The guidance screen informs the customer that confirmation by a clerk is required at the time of checkout.

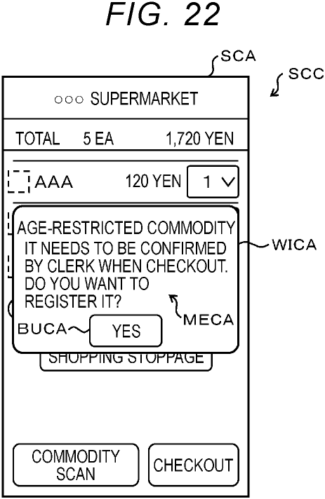

FIG. 22 is a diagram showing an example of the guidance screen SCC.

The guidance screen SCC is a screen in which a window WICA is superimposed on the list screen SCA. The window WICA includes a message MECA and a button BUCA. The message MECA is a text message indicating that confirmation by a clerk is required at the time of checkout. The button BUCA is a software key for the customer to declare that the guidance on the guidance screen SCC was confirmed. The processor 301 generates the list screen SCA showing the commodity names, prices, and quantities of the purchased commodities included in the instruction data, and superimposes the window WICA on the generated list screen to generate the guidance screen SCC.

After confirming the guidance on the guidance screen SCC, the customer declares that the confirmation was made by a predetermined operation such as touching the button BUCA on the guidance screen SCC. In response to this, the processor 301 returns from ACT 123 in FIG. 11 to ACT 112 in FIG. 10 and controls the touch panel 304 to display the list screen SCA, again. The processor 301 may return from ACT 123 to ACT 112 if the elapsed time in the state where the guidance screen SCC is displayed reaches a predetermined time.

If the customer touches the area showing the quantity on the list screen SCA, the processor 301 updates the list screen SCA to display a list box for specifying the quantity. Then, if this list box is operated, the processor 301 receives the operation for the quantity. Then, the processor 301 determines YES at ACT 114 in FIG. 10 and proceeds to ACT 124 in FIG. 11.

As ACT 124, the processor 301 checks whether the specified number is 0. Then, the processor 301 determines NO if the specified number is not 0, and proceeds to ACT 125.

As ACT 125, the processor 301 requests the mobile controller 3 to change the quantity. The request data transmitted by the processor 301 includes specifying data for specifying a commodity for which the quantity is specified, and a specified number. The specifying data may be a commodity code or may be data that can specify the purchased commodity only by the mobile controller 3, such as a number for identifying each purchased commodity in the list of purchased commodities. If the commodity code is used as the specifying code, the processor 31 includes the commodity code for each purchased commodity in the instruction data for instructing the display of the list screen or the instruction data for instructing the display of the guidance screen.

In the mobile controller 3, if the quantity change is requested by the user terminal 300 as described above, the processor 31 determines YES in ACT 206 in FIG. 14, and proceeds to ACT 219 in FIG. 15.

As ACT 219, the processor 31 controls the communication interface 34 to transmit the request for quantity change to the virtual POS server 2 with the notification of the transaction code of the transaction to be processed. At this time, the processor 31 may control the communication interface 34 to transmit the request data sent from the user terminal 300 to the virtual POS server 2 as it is or transmit the request data converted by some processing to the virtual POS server 2. However, the processor 31 notifies the virtual POS server 2 of the quantity included in the request data sent from the user terminal 300. If the specifying data included in the request data is not a commodity code, the processor 31 replaces the specifying data with the commodity code.

In the virtual POS server 2, the processor 21 considers the quantity included in the request data sent from the mobile controller 3 as the one input by the input device of a conventional POS terminal, and changes the quantities of purchased commodities by the same processing as that of the conventional POS terminal. The processor 21 controls the communication interface 24 to transmit the result data representing the commodity code of the commodity whose quantity was changed and the changed quantity to the mobile controller 3.

In the mobile controller 3, the processor 31 proceeds to ACT 220 after transmitting the request for quantity change in ACT 219.

As ACT 220, the processor 31 acquires the result data transmitted from the virtual POS server 2 as described above. The processor 31 stores the acquired result data in the main memory 32 or the auxiliary storage unit 33.

As ACT 221, the processor 31 updates the registration database DBD based on the above result data. That is, the processor 31 finds out the registration data including the notified commodity code from the data record DRB associated with the transaction to be processed. Then, the processor 31 rewrites the quantity included in the corresponding registration data to the quantity included in the result data.

The processor 31 may store the specifying data and the quantity sent in the quantity change request data in the main memory 32 or the auxiliary storage unit 33 and may rewrite the quantity in the registration data related to the commodity specified by the stored specifying data to the stored quantity according to the reception of the result data indicating that the update was completed. In such a case, the processor 21 in the virtual POS server 2 does not have to include the commodity code and the quantity in the result data.

As ACT 222, the processor 31 instructs the user terminal 300 to display the list screen. For example, the processor 31 controls the communication interface 34 to transmit instruction data including identification data for identifying that it is a display instruction of the list screen to the user terminal 300 via the in-store communication network 7 and the access point 6. The processor 31 includes the commodity code, commodity name, price, and quantity included in the registration data in which the cancellation flag is “0” in the registration data included in the updated data record DRB as described above in the instruction data. After that, the processor 31 returns to the standby state of ACT 205 to ACT 209 in FIG. 14.

If the designated number is 0, the processor 301 in the user terminal 300 determines YES in ACT 124 of FIG. 11 and proceeds to ACT 126.

As ACT 126, the processor 301 controls the touch panel 304 to display a deletion screen. The deletion screen notifies the customer that the commodity for which the quantity is specified to be 0 will be deleted from the purchased commodities. The deletion screen includes a delete button for instructing the deletion and a return button for instructing the return to the state before instructing the change of the quantity without changing the quantity.

As ACT 127, the processor 301 checks whether deletion is instructed. Then, if the corresponding instruction cannot be confirmed, the processor 301 determines NO and proceeds to ACT 128.

As ACT 128, the processor 301 checks whether a return is instructed. Then, if the corresponding instruction cannot be confirmed, the processor 301 determines NO and returns to ACT 127.

Thus, the processor 301 waits for the deletion or the return to be instructed, as ACT 127 and ACT 128.

If the customer desires to cancel the deletion and return to the state before instructing the quantity change, the customer instructs the return by a predetermined operation such as touching the return button on the deletion screen. In response to this, the processor 301 determines YES in ACT 128, returns to ACT 112 in FIG. 10, and controls the touch panel 304 to display the list screen SCA, again. In such a case, since the registration state of the purchased commodities is not changed, the processor 301 controls the touch panel 304 to display the list screen SCA in the same state as that displayed before displaying the deletion screen, again.

If there is no mistake in deleting, the customer instructs the deletion by a predetermined operation such as touching the delete button on the deletion screen. In response to this, the processor 301 determines YES in ACT 127 and proceeds to ACT 129.

As ACT 129, the processor 301 requests the mobile controller 3 for deletion. The request data generated by the processor 301 includes specifying data for specifying the commodity for which deletion is instructed.

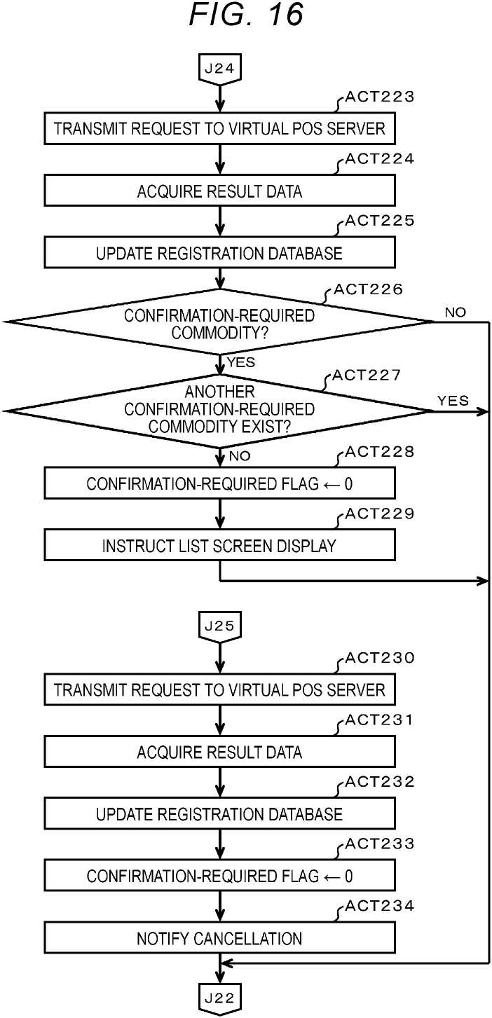

In the mobile controller 3, if the deletion is requested from the user terminal 300 as described above, the processor 31 determines YES in ACT 207 in FIG. 14 and proceeds to ACT 223 in FIG. 16.

As ACT 223, the processor 31 controls the communication interface 34 to transmit the deletion request to the virtual POS server 2 with the notification of the transaction code of the transaction to be processed. At this time, the processor 31 may control the communication interface 34 to transmit the request data sent from the user terminal 300 to the virtual POS server 2 as it is or transmit the request data converted by some processing to the virtual POS server 2. However, if the specifying data included in the request data is not a commodity code, the processor 31 replaces the specifying data with the commodity code.

In the virtual POS server 2, the processor 21 regards the request by the request data sent from the mobile controller 3 as a deletion instruction input by the input device of a conventional POS terminal and excludes the target commodity from the purchased commodities by the same processing as that of the conventional POS terminal. The processor 21 controls the communication interface 24 to transmit the result data representing the commodity code of the commodity excluded from the purchased commodities to the mobile controller 3.

The processor 31 in the mobile controller 3 proceeds to ACT 224 after the deletion request is transmitted in ACT 223.

As ACT 224, the processor 31 acquires the result data transmitted from the virtual POS server as described above. The processor 31 stores the acquired result data in the main memory 32 or the auxiliary storage unit 33.

As ACT 225, the processor 31 updates the registration database DBD based on the above result data. That is, the processor 31 finds out the registration data including the notified commodity code from the data record DRB associated with the transaction to be processed. Then, the processor 31 changes the cancellation flag included in the corresponding registration data to “1”.

The processor 31 may store the specifying data sent in the deletion request data in the main memory 32 or the auxiliary storage unit 33 and change the cancellation flag of the registration data related to the commodity specified by the stored specifying data upon receiving the result data indicating that the deletion was completed. In such a case, the processor 21 in the virtual POS server 2 does not have to include the commodity code in the result data.

As ACT 226, the processor 301 checks whether the deleted commodity is a confirmation-required commodity. Then, the processor 301 determines YES if the deleted commodity is a confirmation-required commodity, and proceeds to ACT 227.

As ACT 227, the processor 301 checks whether there is another confirmation-required commodity in the purchased commodities of the transaction to be processed. Then, the processor 301 determines NO if there is no corresponding commodity, and proceeds to ACT 228. That is, the processor 301 proceeds to ACT 228 if the purchased commodities do not include any confirmation-required commodity due to the deletion of the commodity this time.

As ACT 228, the processor 301 changes the confirmation-required flag set in the field FAD to “0” for the data record DRA associated with the transaction to be processed in the transaction management database DBC.

As ACT 229, the processor 31 instructs the user terminal 300 to display the list screen. For example, the processor 31 controls the communication interface 34 to transmit instruction data including identification data for identifying that it is a display instruction of the list screen to the user terminal 300 via the in-store communication network 7 and the access point 6. The processor 31 includes the commodity code, commodity name, price, and quantity included in the registration data in which the cancellation flag is “0” in the registration data included in the data record DRB updated as described above in the instruction data. After that, the processor 31 returns to the standby state of ACT 205 to ACT 209 in FIG. 14. The processor 31 skips ACT 228 and ACT 229 and returns to the standby state of ACT 205 to ACT 209 in FIG. 14 if it is determined NO in ACT 226 because the deleted commodity is not a confirmation-required commodity, and if it is determined YES in ACT 227 because there is another confirmation-required commodity.

Now, in the user terminal 300, after requesting the quantity change in ACT 125 or requesting the deletion in ACT 129, the processor 301 proceeds to ACT 130.

As ACT 130, the processor 301 waits for an instruction to display the list screen. Then, the processor 301 determines YES if the display of the list screen is instructed by the mobile controller 3 as described above in response to the request for quantity change or the deletion request, returns to ACT 112 in FIG. 10, and controls the touch panel 304 to display the list screen SCA, again. At this time, the list screen SCA is displayed as a screen showing the commodity names, prices, and quantities of the purchased commodities included in the instruction data. In such a case, since the registration state of the purchased commodity is changed, the processor 301 controls the touch panel 304 to display the list screen SCA showing purchased commodities different from the one displayed if the quantity change or deletion is instructed.

If the customer desires to cancel all the purchased commodities that were already registered and stop the shopping, the customer instructs the stoppage by a predetermined operation such as touching the button BUAA on the list screen SCA. In response to this, the processor 301 determines YES in ACT 115, and proceeds to ACT 131 in FIG. 11.

As ACT 131, the processor 301 controls the touch panel 304 to display a cancellation screen. The cancellation screen notifies the customer that all the purchased commodities that were already registered will be canceled. The cancellation screen includes an execution button for instructing a cancellation execution and a return button for instructing a return to the state before the cancellation execution was instructed without executing the cancellation.

As ACT 132, the processor 301 checks whether a cancellation execution is instructed. Then, if the corresponding instruction cannot be confirmed, the processor 301 determines NO and proceeds to ACT 133.

As ACT 133, the processor 301 checks whether the return is instructed. Then, if the corresponding instruction cannot be confirmed, the processor 301 determines NO and returns to ACT 132.

Thus, the processor 301 waits for a cancellation execution or return to be instructed, as ACT 132 and ACT 133.

If the customer desires to continue shopping as it is, the customer instructs a return by a predetermined operation such as touching the return button on the cancellation screen. In response to this, the processor 301 determines YES in ACT 133, returns to ACT 112 in FIG. 10, and controls the touch panel 304 to display the list screen SCA, again. In such a case, since the registration state of the purchased commodities is not changed, the processor 301 controls the touch panel 304 to display the list screen SCA in the same state as displayed before displaying the cancellation screen, again.

If the customer cancels the shopping, the customer instructs the cancellation execution by a predetermined operation such as touching the execution button on the cancellation screen. In response to this, the processor 301 determines YES in ACT 132 and proceeds to ACT 134.

As ACT 134, the processor 301 requests the mobile controller 3 for cancellation.

If the cancellation is requested by the user terminal 300 as described above, the processor 31 in the mobile controller 3 determines YES in ACT 208 in FIG. 14 and proceeds to ACT 230 in FIG. 16.

As ACT 230, the processor 31 controls the communication interface 34 to transmit the cancellation request to the virtual POS server 2 with the notification of the transaction code of the transaction to be processed. At this time, the processor 31 may control the communication interface 34 to transmit the request data sent from the user terminal 300 to the virtual POS server 2 as it is or transmit the request data converted by some processing to the virtual POS server 2.

In the virtual POS server 2, the processor 21 regards the request by the request data sent from the mobile controller 3 as a cancellation instruction input by the input device of a conventional POS terminal and excludes all the registered commodities associated with the notified transaction code from the purchased commodities by the same processing as that of the conventional POS terminal. The processor 21 controls the communication interface 24 to transmit the result data representing that the cancellation was completed to the mobile controller 3.

The processor 31 in the mobile controller 3 proceeds to ACT 231 after transmitting the deletion request in ACT 230.

As ACT 231, the processor 31 acquires the result data transmitted from the virtual POS server as described above. The processor 31 stores the acquired result data in the main memory 32 or the auxiliary storage unit 33.

As ACT 232, the processor 31 updates the registration database DBD based on the above result data. That is, the processor 31 changes the cancellation flag, which is “0”, to “1” for all the registration data included in the data record DRB associated with the transaction to be processed.

As ACT 233, the processor 301 changes the confirmation-required flag set in the field FAD to “0” for the data record DRA associated with the transaction to be processed in the transaction management database DBC.

As ACT 234, the processor 31 notifies the user terminal 300 of the cancellation. After that, the processor 31 returns to the standby state of ACT 205 to ACT 209 in FIG. 14.

Now, the processor 301 in the user terminal 300 proceeds to ACT 135 after requesting the cancellation in ACT 134.

As ACT 135, the processor 301 waits for the cancellation notification from the mobile controller 3. Then, the processor 301 determines YES if the cancellation is notified as described above, and returns to ACT 101 in FIG. 9.

If the customer completed the registration of all the commodities desired to purchase as purchased commodities, the process proceeds to a payment process. At this time, the customer instructs the start of checkout by a predetermined operation such as touching the button BUAC on the list screen SCA. In response to this, the processor 301 determines YES in ACT 116 in FIG. 10, and proceeds to ACT 136.

As ACT 136, the processor 301 requests the mobile controller 3 for checkout.

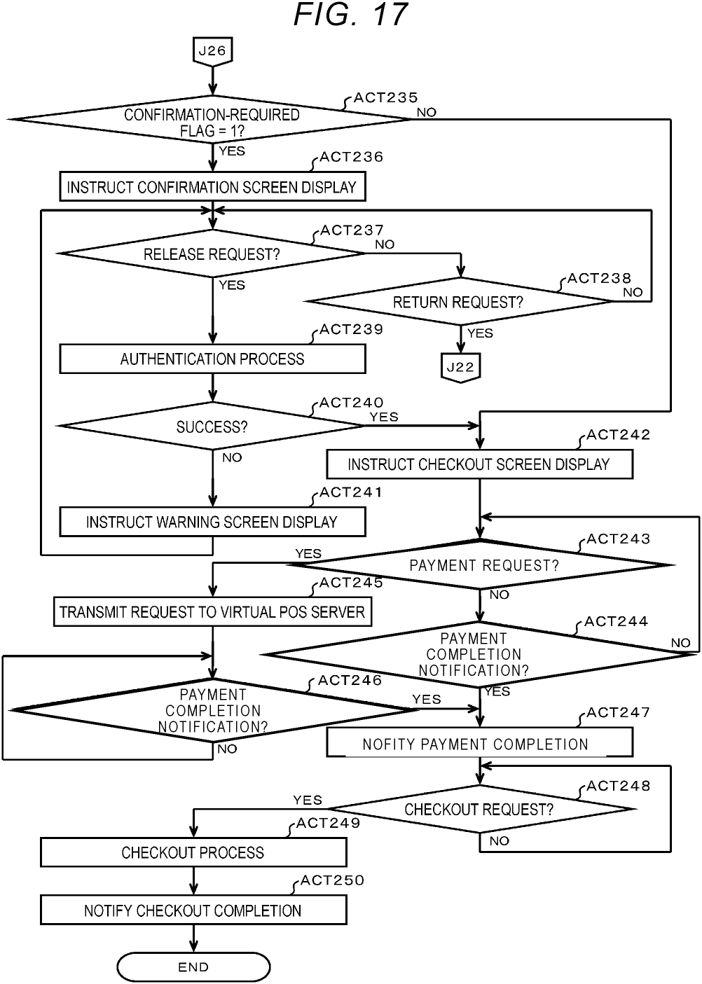

In the mobile controller 3, if the checkout is requested from the user terminal 300 as described above, the processor 31 determines YES in ACT 209 in FIG. 14 and proceeds to ACT 235 in FIG. 17.

As ACT 235, the processor 31 checks whether the confirmation-required flag set in the field FAD for the data record DRA associated with the transaction to be processed in the transaction management database DBC is “1”. That is, the processor 31 checks whether the purchased commodities include a confirmation-required commodity. Then, if the corresponding confirmation-required flag is “1”, that is, if the purchased commodities include a confirmation-required commodity, the processor 31 determines YES, and proceeds to ACT 236. In the following, the state in which the purchased commodities include a confirmation-required commodity and the sale of the confirmation-required commodity is not confirmed to be permitted by a clerk is referred to as a confirmation-required state.

As ACT 236, the processor 31 instructs the user terminal 300 to display the confirmation screen.

Now, the processor 301 in the user terminal 300 proceeds to ACT 137 after requesting checkout in ACT 136 in FIG. 10.

As ACT 137, the processor 301 checks whether the display of a confirmation screen is instructed. Then, if the corresponding instruction cannot be confirmed, the processor 301 determines NO and proceeds to ACT 138.

As ACT 138, the processor 301 checks whether the display of the checkout screen is instructed. Then, if the corresponding instruction cannot be confirmed, the processor 301 determines NO and returns to ACT 137.

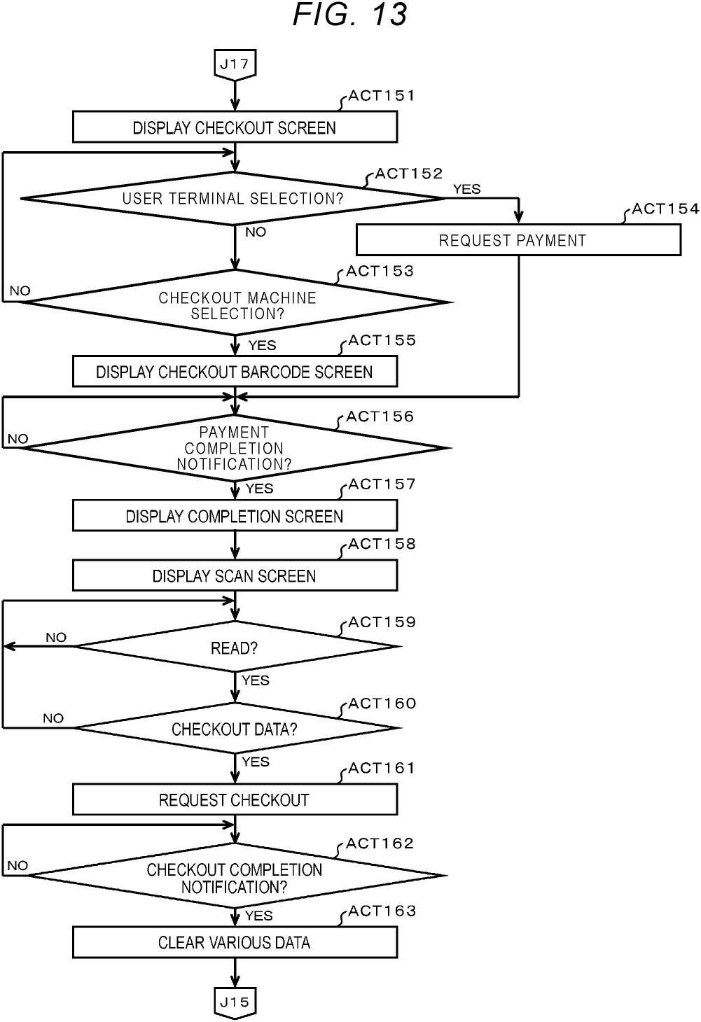

Thus, the processor 301 waits to be instructed to display the confirmation screen or the checkout screen, as ACT 137 and ACT 138. Then, if the display of the confirmation screen is instructed by the mobile controller 3 as described above, the processor 301 determines YES in ACT 137 and proceeds to ACT 139 in FIG. 12.

As ACT 139, the processor 301 controls the touch panel 304 to display a confirmation screen for prompting the customer to contact a clerk to confirm the confirmation-required commodity.

FIG. 23 is a diagram showing an example of the confirmation screen SCD.

The confirmation screen SCD is a screen in which a window WIDA is superimposed on the list screen SCA displayed immediately before. The window WIDA includes a message MEDA and buttons BUDA and BUDB. The message MEDA is a text message indicating that it is necessary to contact a clerk to confirm the confirmation-required commodity. The button BUDA is a software key for a customer to confirm to receive confirmation by a clerk. The button BUDB is a software key for the customer to return to the commodity registration.

If the customer decides to receive the confirmation by a clerk, the customer performs a predetermined operation such as touching the button BUDA. If the customer decides to cancel the checkout and return to the commodity registration, the customer performs a predetermined operation such as touching the button BUDB.

As ACT 140 in FIG. 12, the processor 301 checks whether the confirmation is to be received. Then, if the corresponding instruction cannot be confirmed, the processor 301 determines NO and proceeds to ACT 141.

As ACT 141, the processor 301 checks whether the return is instructed. Then, if the corresponding instruction cannot be confirmed, the processor 301 determines NO and returns to ACT 140.

Thus, the processor 301 waits for confirmation or return to be instructed, as ACT 140 and ACT 141. Then, if the confirmation is instructed as described above, the processor 301 determines YES in ACT 140 and proceeds to ACT 142.

As ACT 142, the processor 301 controls the touch panel 304 to display a release screen through which the user terminal 300 reads a barcode for releasing the confirmation waiting state by a clerk who confirmed that the sale of the confirmation-required commodity is permitted.

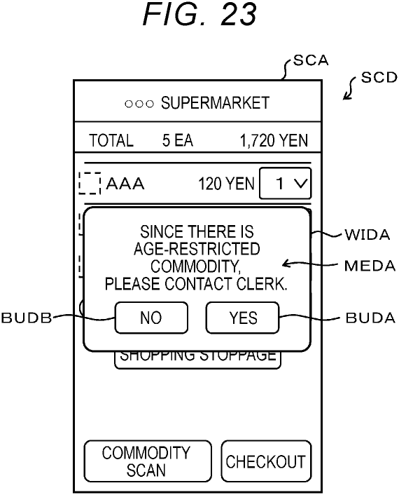

FIG. 24 is a diagram showing an example of a release screen SCE.

The release screen SCE includes a display area AREA, a message MEEA, and a button BUEA. The display area AREA displays an image obtained by the camera 305. The message MEEA is a text message that prompts a clerk to present a barcode for releasing the confirmation-required state. The button BUEA is a software key for the customer or the clerk to declare to stop the scanning of the release barcode.

For example, the processor 301 activates the camera 305 and generates the release screen SCE by overlapping the image obtained by the camera 305 with the lines showing the range of the display area AREA and the image showing the message MEEA and the button BUEA.

Now, in the mobile controller 3, if the transaction assisting processing is being executed, the processor 31 executes information processing based on the monitoring assisting application APD (hereinafter referred to as monitoring assisting processing) in parallel with the transaction assisting processing.

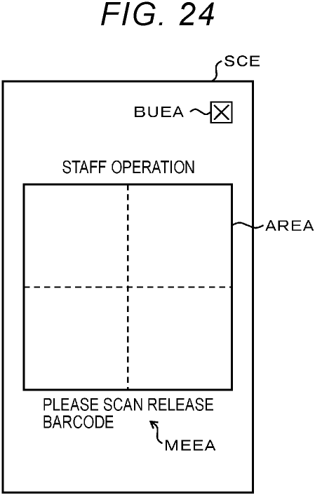

FIG. 25 is a flowchart of the monitoring assisting processing by the processor 31.

As ACT 301, the processor 31 generates a monitoring screen and instructs the monitoring terminal 400 to display the monitoring screen. For example, the processor 31 controls the wireless communication unit 306 to transmit the instruction data including the identification data for identifying that it is a display instruction of the monitoring screen and the screen data of the monitoring screen to the monitoring terminal 400 via the in-store communication network 7 and the access point 6. In the monitoring terminal 400, if such instruction data is received by the wireless communication unit 406, the processor 401 controls the touch panel 404 to display the monitoring screen.

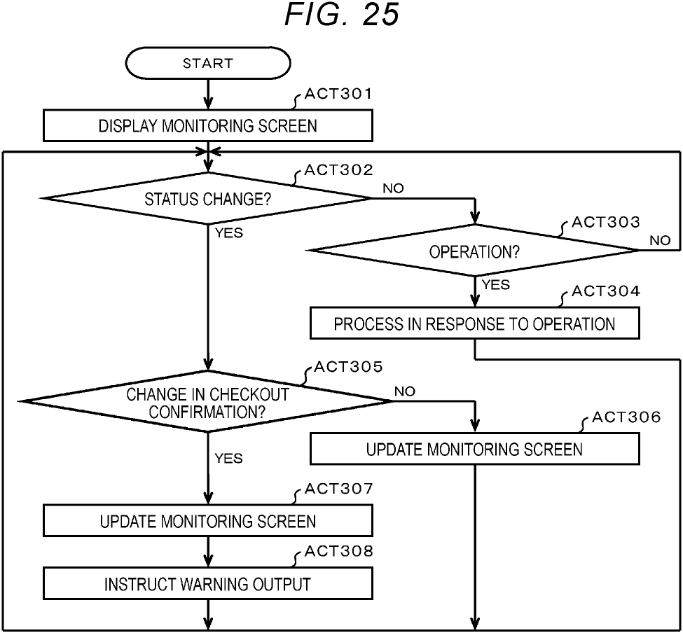

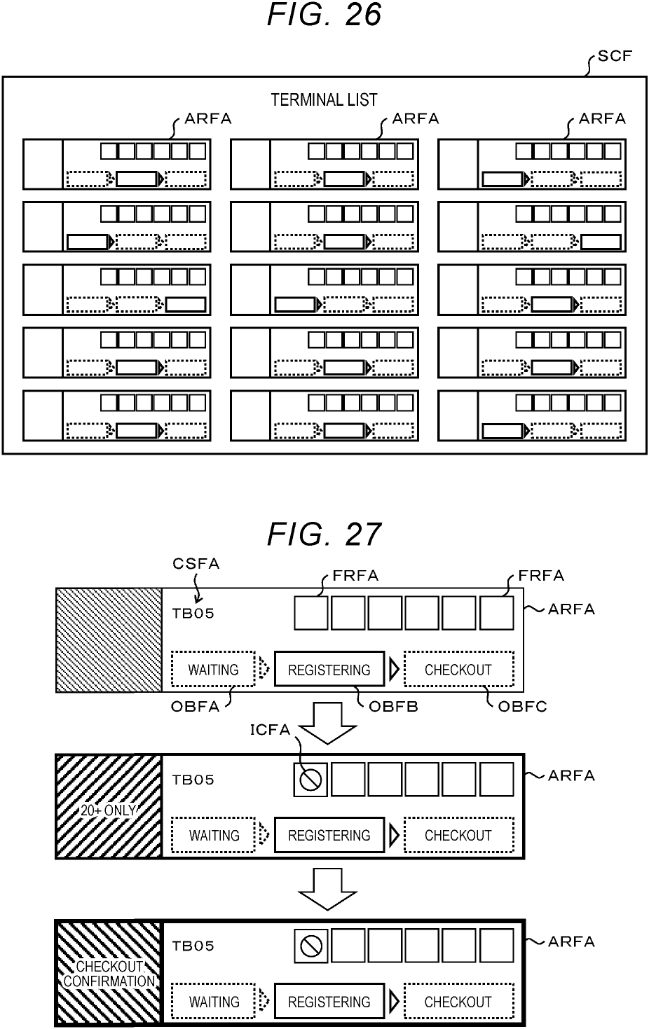

FIG. 26 is a diagram showing an outline of the entire monitoring screen SCF as an example.

The monitoring screen SCF includes a display area ARFA associated with each of the user terminals 300 being checked in. The display area ARFA shows the status of the transaction being executed for the associated user terminal 300.

FIG. 27 is a diagram showing one detail of the display area ARFA in FIG. 26. FIG. 27 shows an example of the transition of the display in one display area ARFA. The upper part of FIG. 27 shows an example of the normal display state of the display area ARAF.

In the display area ARAF, a character string CSFA, a plurality of frame lines FRFA, and display objects OBFA, OBFB, and OBFC are arranged as shown in the drawing. The character string CSFA shows a number for identifying a user terminal 300 in the transaction processing system. The border FRFA shows an area for displaying various icons. In the upper part of FIG. 27, the icon is not displayed. The display objects OBFA, OBFB, and OBFC are associated with the “waiting”, “registering”, and “checkout” states, respectively. Then, any one of the display objects OBFA, OBFB, and OBFC is in the active state, and the remaining two are in the inactive state. In FIG. 27, the frame line of the display object OBFB in the active state is represented by a solid line, and the frame line of the display objects OBFA and OBFC in the inactive state is represented by a broken line. The inactive state is assumed to be, for example, a gray-out display. The display object OBFA becomes in the active state before the commodity registration related to the corresponding transaction is started. The display object OBFB becomes in the active state during the commodity registration related to the corresponding transaction. The display object OBFC becomes in the active state during checkout for the commodities subject to the transaction.

As ACT 302 in FIG. 25, the processor 31 checks whether the status of any of all the transaction assisting processing being executed changed. Then, if the corresponding event cannot be confirmed, the processor 31 determines NO and proceeds to ACT 303.

As ACT 303, the processor 31 checks whether any operation was performed on the monitoring screen. Then, if the corresponding event cannot be confirmed, the processor 31 determines NO and returns to ACT 302.

Thus, the processor 31 waits for the status change or an operation, as ACT 302 and ACT 303.

In the monitoring terminal 400, if the clerk performs a predetermined operation on the monitoring screen, the processor 401 controls the wireless communication unit 406 to transmit notification data for notifying the content of the operation to the mobile controller 3. If this notification data is taken in by the communication interface 34, the processor 31 determines YES in ACT 303 and proceeds to ACT 304.

As ACT 304, the processor 31 executes the processing according to the performed operation. The processing of the processor 31 here can include determining what kind of operation was performed by a clerk and executing the processing according to the operation, but the detailed description thereof will be omitted here. For example, if one of the display areas ARFA is touched by a clerk on the monitoring screen SCF, the processor 31 pops up a window showing, for example, a list of commodities registered for the associated transaction in the corresponding display area ARFA. Then, if the processor 31 completes the processing corresponding to the operation, the processor 31 returns to the standby state of ACT 302 and ACT 303.

If the status to be displayed on the monitoring screen changes with respect to any of the transactions subject to the transaction assisting processing, the processor 31 determines YES in ACT 302 and proceeds to ACT 305.

As ACT 305, the processor 31 checks whether the status after the change is “checkout confirmation”. Then, if the corresponding event cannot be confirmed, the processor 31 determines NO and proceeds to ACT 306.

As ACT 306, the processor 31 updates the monitoring screen to reflect the change in status. The processing of the processor 31 here can include determining which status changed and how for which transaction, and updating the monitoring screen to change the display in the display area associated with the corresponding transaction. However, the detailed description thereof will be omitted here. One specific example will be described below.

In the user terminal 300 managed by the number “TB05”, the commodity having an age restriction for a purchaser is registered from the state where the commodity having an age restriction for a purchaser is not included in the already registered commodities. In such a case, the status related to the transaction changes to “age-restricted commodity exists”. In response to this, the processor 31 updates the monitoring screen so that the display of the display area ARFA, which was the display state shown in the upper part of FIG. 27, is changed to the display state shown in the middle part, for example. That is, the processor 31 arranges an icon ICFA indicating that a commodity having an age restriction for a purchaser is included as a purchased commodity inside one frame line FRFA. The processor 31 changes the display color of the line indicating the outer frame of the corresponding display area ARFA from blue to yellow. The processor 31 also changes the background color of a partial area of the display area ARFA from blue to yellow. In FIG. 27, the difference in the width of the line indicating the outer frame of the display area ARFA and hatching shows the difference in the display color. The processor 31 represents a character string of “20+ only” indicating that “there is an age-restricted commodity” in the area where the background color is yellow.

Then, if the update of the monitoring screen is finished, the processor 31 returns to the standby state of ACT 302 and ACT 303.

Now, if the processor 31 causes the user terminal 300 to display the confirmation screen as described above in the transaction assisting processing, the status of the corresponding transaction becomes “checkout confirmation”. Therefore, in the monitoring assisting processing, the processor 31 determines YES in ACT 305 in FIG. 25 and proceeds to ACT 307. As described above, the confirmation screen is displayed if the start of checkout is instructed to proceed to payment, and the processor 31 determining YES in ACT 305 corresponds to detecting that the payment instruction was made. Thus, if the processor 31 executes information processing based on the monitoring assisting application APD, the processor 31 functions as a detection unit.

As ACT 307, the processor 31 updates the monitoring screen. Here, since checkout for a transaction in which an age-restricted commodity is registered as a purchased commodity is requested, the display area ARFA associated with the corresponding transaction is, for example, in the display state shown in the middle part of FIG. 27. Therefore, the processor 31 updates the monitoring screen to become the display state shown in the lower part. That is, the processor 31 changes the display color of the line representing the outer frame of the corresponding display area ARFA from yellow to red. The processor 31 also changes the background color of a partial area of the display area ARFA from yellow to red. The processor 31 shows the character string “checkout confirmation” in the area where the background color is red.

As ACT 308, the processor 31 instructs the monitoring terminal 400 to output an alarm. For example, the processor 31 controls the communication interface 34 to transmit instruction data including identification data for identifying that it is a display instruction of the monitoring screen to the monitoring terminal 400 via the in-store communication network 7 and the access point 6. In the monitoring terminal 400, if such instruction data is received by the wireless communication unit 406, the processor 401 causes the sound unit 405 to output a predetermined sound. It is assumed that the sound output by the sound unit 405 is a predetermined alarm sound or a voice message.

Then, the processor 31 returns to the standby state of ACT 302 and ACT 303 after this.

As described above, the display on the monitoring screen and the sound output notify a clerk that the payment for a transaction including a confirmation-required commodity as a purchased commodity was instructed. Thus, if the processor 31 executes information processing based on the monitoring assisting application APD, the processor 31 functions as a notification unit. The mobile controller 3 corresponds to an information processing device provided with the detection unit and the notification unit.

The customer requests a clerk for confirmation. The clerk can recognize in advance that the customer will request confirmation by the above-mentioned change in the display on the monitoring screen and the sound output by the sound unit 405, and can thus prepare for performance of required actions in response to the request. After the clerk receives the request, the clerk checks whether the sale of the confirmation-required commodity is permitted (that is, permissible in view of the applicable controls on the commodity), and if it is permitted, the clerk holds the release barcode toward the camera 305 so that the release barcode is reflected in the display area AREA. The clerk may have a card or the like with such a release barcode printed thereon for this confirmation work. Alternatively, the clerk presents a release barcode displayed on the screen of an information terminal in his/her possession. The release barcode is preferably different for each store or each business operator. However, it is permissible for different stores or different business operators to use the same release barcode. By changing the normal release barcode periodically, for example, every day, it is possible to prevent fraud if a release barcode were to be acquired at some point by a customer for some reason.

If the clerk decides that the sale of the confirmation-required commodity is not permitted, the clerk instructs a return to the commodity registration by a predetermined operation such as touching the button BUEA. Alternatively, if the customer decides to return to the commodity registration without requesting the clerk provide the necessary confirmation, the customer instructs a return (or cancellation) of the registered commodity by a predetermined operation such as touching the button BUEA.

As ACT 143, the processor 301 checks whether the barcode was read. At this time, the processor 301 analyzes the image obtained by the camera 305 and attempts to read the barcode. The barcode reading may be performed as a process based on the smartphone POS application APE or may be performed as a process based on another application program for reading the barcode. If the barcode cannot be read, the processor 301 determines NO and proceeds to ACT 144.

As ACT 144, the processor 301 checks whether the return is instructed. Then, if the corresponding instruction cannot be confirmed, the processor 301 determines NO and returns to ACT 143.

Thus, the processor 301 waits for the barcode to be read or for a return to be instructed, as ACT 143 and ACT 144.

If the return is instructed as described above, the processor 301 determines YES in ACT 144 and proceeds to ACT 145. If the return is instructed as described above in the state where the confirmation screen SCD is displayed on the touch panel 304, the processor 301 determines YES in ACT 141 and proceeds to ACT 145.

As ACT 145, the processor 301 requests the mobile controller 3 to return to the commodity registration. Then, the processor 301 returns to ACT 112 in FIG. 10.

Now, the processor 31 in the mobile controller 3 proceeds to ACT 237 after instructing the display of the confirmation screen in ACT 236 of FIG. 17.

As ACT 237, the processor 31 checks whether the release is requested. Then, if the corresponding request cannot be confirmed, the processor 31 determines NO and proceeds to ACT 238.

As ACT 238, the processor 31 checks whether the return is requested. Then, if the corresponding request cannot be confirmed, the processor 31 determines NO and returns to ACT 237.

Thus, the processor 31 waits for a release or return to be requested, as ACT 237 and ACT 238. Then, if the return to the commodity registration is requested from the user terminal 300 as described above, the processor 31 determines YES in ACT 238 and returns to the standby state of ACT 205 to ACT 209 in FIG. 14.

That is, both the mobile controller 3 and the user terminal 300 return to the state of performing commodity registration.

On the other hand, in the user terminal 300, if the barcode is reflected in the image taken by the camera 305, the processor 301 determines YES in ACT 143 in FIG. 12 and proceeds to ACT 146.

As ACT 146, the processor 301 stores the barcode data represented by the read barcode in the main memory 302 or the auxiliary storage unit 303.

As ACT 147, the processor 301 requests the mobile controller 3 to release the confirmation-required state. The processor 301 includes the stored barcode data in the request data transmitted here. The processor 301 includes the authentication data included in the check-in data stored in ACT 107 in FIG. 9 in the request data transmitted here.

If the release is requested from the user terminal 300 to the mobile controller 3 in this way, the processor 31 in the mobile controller 3 determines YES in ACT 237 in FIG. 17 and proceeds to ACT 239.

As ACT 239, the processor 31 performs an authentication process. For example, the processor 31 retrieves the barcode data and the authentication data from the request data and stores the retrieved barcode data and authentication data in the main memory 32 or the auxiliary storage unit 33. Then, the processor 31 performs a process of checking whether the read barcode is a normal barcode for release based on the barcode data and the authentication data acquired in this way. This authentication process can be performed by any of the followings, for example.
(1) If the barcode data and the authentication data match, the processor 31 determines that the normal barcode for release was read.
(2) If the processor 31 processes the barcode data by a predetermined algorithm and the data obtained as a result and the authentication data match, the processor 31 determines that the normal barcode for release was read.
(3) If the processor 31 processes the authentication data by a predetermined algorithm and the data obtained as a result and the barcode data match, the processor 31 determines that the normal barcode for release was read.
(4) The processor 31 processes the barcode data by a predetermined first algorithm, and processes the authentication data by a predetermined second algorithm. Then, if the two data obtained as a result of this match each other, it is determined that the normal barcode for release was read.

In addition, any process for confirming that the barcode data and the authentication data have a predetermined relationship can be applied. Then, if it is confirmed that the barcode data and the authentication data have a predetermined relationship, the processor may determine that the normal barcode for release was read.

As ACT 240, the processor 31 checks whether the authentication was successful. Then, if the authentication fails, the processor 31 determines NO and proceeds to ACT 241.

As ACT 241, the processor 31 instructs the user terminal 300 to display a warning screen. Then, the processor 31 returns to the standby state of ACT 237 and ACT 238.

The processor 301 in the user terminal 300 proceeds to ACT 148 after requesting the release in ACT 147 in FIG. 12.

As ACT 148, the processor 301 checks whether the display of the warning screen is instructed. Then, if the corresponding instruction cannot be confirmed, the processor 301 determines NO and proceeds to ACT 149.

As ACT 149, the processor 301 checks whether the display of the checkout screen is instructed. Then, if the corresponding instruction cannot be confirmed, the processor 301 determines NO and returns to ACT 148.

Thus, the processor 301 waits to be instructed to display the warning screen or the checkout screen, as ACT 148 and ACT 149. Then, if the display of the warning screen is instructed by the mobile controller 3 as described above, the processor 301 determines YES in ACT 148 and proceeds to ACT 150.

As ACT 150, the processor 301 controls the touch panel 304 to display a warning screen for warning the clerk that the release barcode presented by the clerk is incorrect.

FIG. 28 is a diagram showing an example of a warning screen SCG.

The warning screen SCG is a screen in which a window WIGA is superimposed on the release screen SCE displayed immediately before. The window WIGA includes a message MEGA and a button BUGA. The message MEGA is a text message indicating that the read barcode is incorrect. The button BUGA is a software key for the clerk to declare that the notification of the warning screen SCG was confirmed.

If the processor 301 is instructed to release the display of the warning screen SCG by a predetermined operation such as touching the button BUGA displayed in the warning screen SCG, the processor 301 returns to ACT 142.

If the processor 31 in the mobile controller 3 succeeds in authentication as a result of the authentication process in ACT 239 in FIG. 17, the processor 31 determines YES in ACT 240 and proceeds to ACT 242. If the confirmation-required flag is “0”, the processor 31 determines NO in ACT 235 and proceeds to ACT 242.

As ACT 242, the processor 31 instructs the user terminal 300 to display the checkout screen. After that, the processor 31 starts the process described below for making a payment for the commodities registered as the purchased commodities by the virtual POS server 2 or the checkout machine 5. That is, the processor 31 allows the start of the payment process if the acquired barcode data is the release data as the data having a predetermined relationship with the authentication data.

Thus, the processor 31 deters the start of the payment process until the release data as the data represented by the release barcode can be acquired. Then, if the release data can be acquired, the processor 31 releases the above deterrence. That is, if the processor 31 executes information processing based on the transaction assisting application APC, the processor 31 functions as a deterrence unit, an acquisition unit, and a release unit.

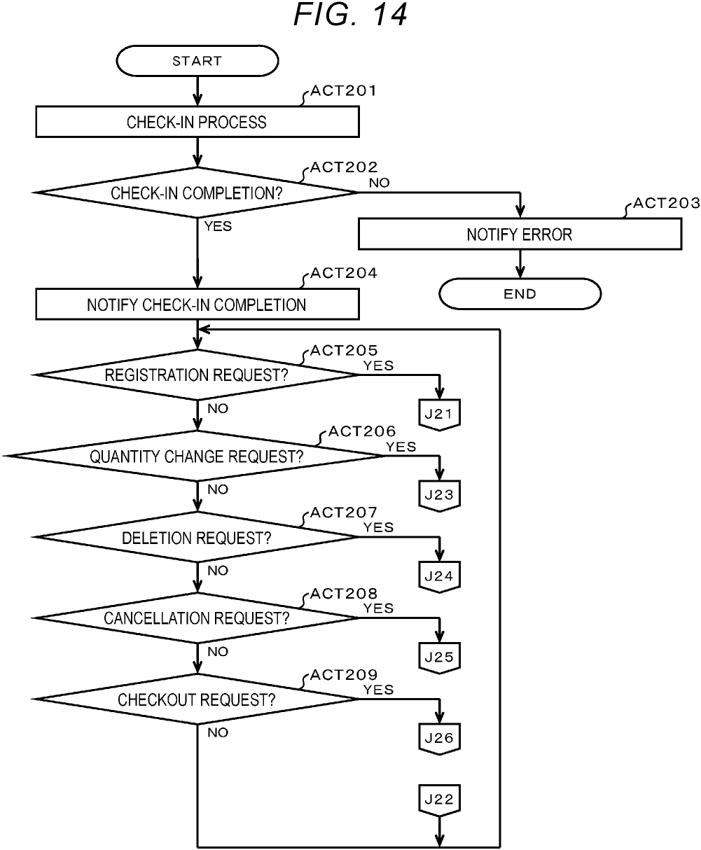

If the processor 31 determines NO in ACT 235 and proceeds to ACT 242, since ACT 236 is skipped, the user terminal 300 is not instructed to display the confirmation screen. Therefore, if the processor 31 instructs the display of the checkout screen in ACT 242, the processor 301 in the user terminal 300 is in the standby state of ACT 137 and ACT 138 in FIG. 10. Therefore, the processor 301 determines YES in ACT 138 in response to the display instruction on the checkout screen and proceeds to ACT 151 in FIG. 13.

If the processor 31 determines YES in ACT 240 and proceeds to ACT 242, the processor 301 in the user terminal 300 is in the standby state of ACT 148 and ACT 149 in FIG. 12 when the processor 31 instructs the display of the checkout screen in ACT 242. Therefore, the processor 301 determines YES in ACT 149 in response to the display instruction on the checkout screen and proceeds to ACT 151 in FIG. 13.

As ACT 151, the processor 301 controls the touch panel 304 to display the checkout screen for the customer to select whether to make payment using the user terminal 300 or the checkout machine 5.

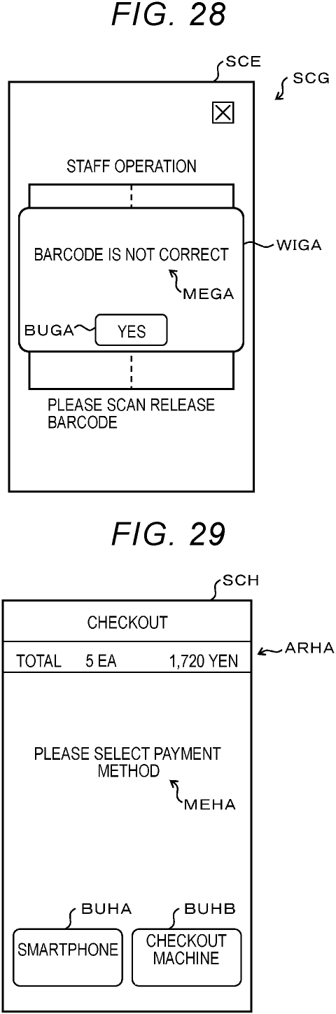

FIG. 29 is a diagram showing an example of a checkout screen SCH.

The checkout screen SCH includes a display area ARHA, a message MEHA, and buttons BUHA and BUHB. The display area ARHA shows the total quantity of purchased commodities and the total price of the purchased commodities. The message MEHA is a text message prompting the customer to designate whether to make payment using the user terminal 300 or the checkout machine 5. The button BUHA is a software key for the customer to select the user terminal 300. The button BUHB is a software key for the customer to select the checkout machine 5.

If the customer desires to make payment using the user terminal 300, the customer selects the user terminal 300 by a predetermined operation such as touching the button BUHA. If the customer desires to make payment using the checkout machine 5, the customer selects the checkout machine 5 by a predetermined operation such as touching the button BUHB.

As ACT 152, the processor 301 checks whether the user terminal 300 was selected. Then, if the corresponding selection cannot be confirmed, the processor 301 determines NO and proceeds to ACT 153.

As ACT 153, the processor 301 checks whether the checkout machine 5 was selected. Then, if the corresponding selection cannot be confirmed, the processor 301 determines NO and returns to ACT 152.

Thus, the processor 301 waits for the user terminal 300 or the checkout machine 5 to be selected, as ACT 152 and ACT 153. Then, if the user terminal 300 is selected as described above, the processor 301 determines YES in ACT 152 and proceeds to ACT 154.

As ACT 154, the processor 301 requests the mobile controller 3 to perform a payment process. The processor 301 includes payment data such as a credit card number or a user code for an online payment service, which is necessary for payment, in the request data for requesting payment.

If the checkout machine 5 is selected as described above, the processor 301 determines YES in ACT 153 and proceeds to ACT 155.

As ACT 155, the processor 301 controls the touch panel 304 to display the checkout barcode screen showing a checkout barcode that represents data necessary for the checkout machine 5 to acquire data related to the contents of a transaction from the virtual POS server 2. Although detailed processing is omitted, the processor 301 acquires a checkout barcode from the virtual POS server 2 via the mobile controller 3 and displays the checkout barcode on the checkout barcode screen.

The customer operates the scanner of the checkout machine 5 not used by other customers to read the checkout barcode. In response to this, the checkout machine 5 acquires data related to the contents of the transaction from the virtual POS server 2 according to the data represented by the checkout barcode and executes a process for paying the payment amount calculated based on this data. Then, if the payment is completed, the checkout machine 5 notifies the virtual POS server 2 of the completion. If the checkout machine 5 notifies the completion of payment, the processor 21 in the virtual POS server 2 notifies the mobile controller 3 of the completion of payment. The completion of payment on the checkout machine 5 may be notified directly from the checkout machine 5 to the mobile controller 3.

The processor 31 in the mobile controller 3 proceeds to ACT 243 after instructing the display of the checkout screen in ACT 242 in FIG. 17.

As ACT 243, the processor 31 checks whether a payment is requested. Then, if the corresponding request cannot be confirmed, the processor 31 determines NO and proceeds to ACT 244.

As ACT 244, the processor 31 checks whether the payment completion was notified. Then, if the corresponding request cannot be confirmed, the processor 31 determines NO and returns to ACT 243.

Thus, the processor 31 waits for the payment request or the payment completion notification, as ACT 243 and ACT 244. Then, if the payment is requested from the user terminal 300 as described above, the processor 31 determines YES in ACT 243 and proceeds to ACT 245.

As ACT 245, the processor 31 transmits the payment request to the virtual POS server 2 with the notification of the transaction code of the transaction to be processed. At this time, the processor 31 may control the communication interface 34 to transmit the request data sent from the user terminal 300 to the virtual POS server 2 as it is, or transmit the request data converted by some processing to the virtual POS server 2.

In the virtual POS server 2, the processor 21 regards the request by the request data sent from the mobile controller 3 as a payment instruction input by the input device of a conventional POS terminal, calculates the price related to the transaction identified by the notified transaction code by the same processing as that of the conventional POS terminal, and performs the process for payment based on the payment data. The process for payment includes, for example, a payment request to a payment server (not shown). Then, the processor 21 controls the communication interface 24 to transmit the result data representing the completion of settlement to the mobile controller 3.

The processor 31 in the mobile controller 3 controls the communication interface 34 to transmit the payment request in ACT 245 and then proceeds to ACT 246.

As ACT 246, the processor 31 waits for the mobile controller 3 to notify the completion of payment. Then, if the result data representing that the payment was completed, which was transmitted by the mobile controller 3 as described above, is received by the communication interface 34, the processor 31 determines YES and proceeds to ACT 247. If the processor 31 is notified of the completion of payment by the checkout machine 5 as described above, the processor 31 determines YES in ACT 244 and proceeds to ACT 247.

As ACT 247, the processor 31 notifies the user terminal 300 of the completion of payment.

The processor 301 in the user terminal 300 requests payment to the mobile controller 3 in ACT 154 in FIG. 13 or controls the touch panel 304 to display the checkout barcode screen in ACT 155, and then proceeds to ACT 156.

As ACT 156, the processor 301 waits for notification of payment completion. Then, if the mobile controller 3 notifies the completion of payment as described above, the processor 301 determines YES and proceeds to ACT 157.

As ACT 157, the processor 301 controls the touch panel 304 to display the completion screen for notifying the customer that the payment was completed.

After confirming the completion screen, the customer declares that the confirmation was made by a predetermined operation such as touching the button displayed on the completion screen. In response to this, the processor 301 proceeds to ACT 158. The processor 301 may proceed to ACT 158 if the elapsed time in the state where the completion screen is displayed reaches a predetermined time.

As ACT 158, the processor 301 controls the touch panel 304 to display a checkout scan screen through which a two-dimensional code TCB can be read for checkout. For example, the processor 301 activates the camera 305, superimposes the image obtained by the camera 305 on a text message prompting the customer to operate the camera 305 to read the two-dimensional code TCB and a line showing the position where the two-dimensional code TCB should be held, and generates the scan screen.

If the scan screen for checkout is displayed on the touch panel 304, the customer points the camera 305 at the two-dimensional code TCB so that the two-dimensional code TCB posted near the exit of the store is reflected on the scan screen.

As ACT 159, the processor 301 waits for the two-dimensional code to be read. At this time, the processor 301 repeatedly analyzes an image obtained by the camera 305 and attempts to read a two-dimensional code. The reading of a two-dimensional code may be performed as a process based on the smartphone POS application APE or may be performed as a process based on another application program for reading the two-dimensional code. Then, if a two-dimensional code is read, the processor 301 determines YES and proceeds to ACT 160.

As ACT 160, the processor 301 checks whether the data represented by the read two-dimensional code is checkout data. Then, the processor 301 determines NO if the data is not checkout data, and returns to ACT 159. At this time, the processor 301 may control the touch panel 304 to display a screen notifying the customer that an erroneous two-dimensional code was read.

If the processor 301 can confirm that the data represented by the read two-dimensional code is checkout data, the processor 301 determines YES in ACT 160 and proceeds to ACT 161.

As ACT 161, the processor 301 requests the mobile controller 3 to check out.

The processor 31 in the mobile controller 3 proceeds to ACT 248 after notifying the completion of payment in ACT 247 of FIG. 17.

As ACT 248, the processor 31 waits for a checkout request. Then, if the checkout is requested from the user terminal 300 as described above, the processor 31 determines YES and proceeds to ACT 249.

As ACT 249, the processor 31 executes a checkout process. The checkout process is a process such as clearing the data stored in the main memory 32 and the auxiliary storage unit 33 for the management of the transaction to be processed. The virtual POS server 2 may end the processing related to the corresponding transaction according to the completion of payment or may end the processing related to the transaction according to the instruction from the mobile controller 3. In the latter case, the processor 31 issues the above instruction to the virtual POS server 2 in the checkout process. In addition, a history database showing the history of user operations including erroneous barcode scanning may be managed by the store server 1, the virtual POS server 2, the mobile controller 3, or another server (not shown). In such a case, in the checkout process, the processor 31 performs a process for updating the history database to reflect the history of operations related to the transaction this time.

As ACT 250, the processor 31 notifies the user terminal 300 of the completion of the checkout. Then, the processor 31 ends the information processing shown in FIGS. 14 to 17.

The processor 301 in the user terminal 300 proceeds to ACT 162 after requesting checkout in ACT 161 in FIG. 13.

As ACT 162, the processor 301 waits for the notification of the completion of checkout. Then, if the checkout completion is notified from the mobile controller 3 as described above, the processor 301 determines YES and proceeds to ACT 163.

As ACT 163, the processor 301 clears various data temporarily used for this shopping, such as the check-in data stored in ACT 107 in FIG. 9. Then, the processor 301 returns to ACT 101 in FIG. 9.

As described above, the mobile controller 3 notifies a clerk if it is detected that a payment instruction was made for a transaction in which a commodity that needs to be confirmed by a clerk at the time of sale is included as a purchased commodity. In this way, it is possible to make the clerk aware that the payment related to the transaction in which a commodity that needs to be confirmed by a clerk is included in the commodities to be purchased is about to be performed. As a result, the clerk can take measures such as prompt confirmation.

The mobile controller 3 does not proceed to the process for payment in the user terminal 300 in the confirmation-required state. However, once the user terminal 300 reads a normal barcode for release, the user terminal 300 proceeds to the process for payment under the authentication by the mobile controller 3. Thus, it is possible to prevent the payment process for a transaction for which a commodity that needs to be confirmed by a clerk at the time of sale is included without confirmation. Since a clerk can recognize that the payment process is being deterred in this way by the above notification, the clerk can take measures to promptly proceed to the payment process.

The mobile controller 3 can also acquire the release data from the user terminal 300. Therefore, to release the confirmation-required state, a clerk only needs to operate the user terminal 300 to read the release barcode, and the work for that is not a heavy burden on the clerk.

The above-recited embodiments can be modified in various ways as follows.

A notification to a clerk may be via either screen display or sound output. Furthermore, notification may be made by another means such as vibration alone or in combination with other methods.

The monitoring assisting processing may be executed by the processor 11 or the processor 21 on the store server 1 or the virtual POS server 2. Alternatively, any other information processing device may be provided inside or outside the store system 100, and the monitoring assisting processing may be executed by a processor provided in such other information processing device. In some examples, the monitoring assisting processing may be executed by the processor 401 on the monitoring terminal 400.

The processor 31 may release the confirmation-required state in response to the release operation by the clerk at the monitoring terminal 400. For example, a release button can be displayed in the display area ARFA associated with the transaction in the confirmation-required state in the monitoring screen, and the processor 31 may release the confirmation-required state according to a notification sent from the monitoring terminal 400 that the release button was pressed.

The data for releasing the confirmation-required state can be acquired by any other method such as acquiring the data designated by a manual input operation or acquiring the recorded data from a recording medium by short-range wireless communication.

The authentication data may be stored in any storage device provided in the store system 100. For example, the authentication data may be stored in the main memory 32 or the auxiliary storage unit 33 in the mobile controller 3.

Confirmation by a clerk may be performed at the time of checkout at a checkout machine, and payment at the checkout machine may then proceed without additional confirmation by a clerk using the user terminal.

If a normal release barcode is read at any time before a customer finishes commodity registration, the confirmation-required flag may be set to “0” to release the confirmation-required state. In this way, if the customer sees a clerk while looking around the store, the customer can request the clerk to release the confirmation-required state. However, in such a case, if a confirmation-required commodity is registered as a purchased commodity after the confirmation-required state is released, the confirmation-required flag is set to “1” and the confirmation-required state is set, so that the confirmation-required state needs to be released again.

The function of the virtual POS server 2 and the function of the mobile controller 3 may be implemented by one server.

The user terminal 300 may be a so-called cart terminal attached to a shopping cart used in a store. That is, the transaction processing system may be implemented as a cart POS system or a cart-based POS system. Alternatively, as the user terminal 300, a terminal carried by a customer and a terminal attached to a shopping cart may coexist together in the same system.

Each function performed by the processors 11, 21, 31, 41, 301, and 401 can be implemented by dedicated hardware or the like that executes information processing that is not based on a software program, such as a logic circuit or the like, in part or whole. Each of the above-mentioned functions can be implemented by combining software control with dedicated hardware such as a logic circuit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device for a point of sales (POS) system in which a commodity can be registered for purchase and a payment request for the commodity can be issued using a mobile terminal operated by a customer in a store, the information processing device comprising:
a memory that stores flag data indicating either a first value indicating that none of commodities that have been registered requires confirmation by a store clerk when payment is made or a second value indicating that at least one of the commodities requires the confirmation; and
a processor configured to:
when a sales transaction is started by the customer using the mobile terminal, initialize the flag data to the first value,
upon receipt of a request for registering a commodity from the mobile terminal, determine whether the commodity requires confirmation by a store clerk,
upon determining that the commodity requires the confirmation, update the flag data to the second value, and
upon receipt of a payment request in association with the transaction, when the flag data indicates the second value, issue a notification for notifying a store clerk that confirmation is required before completing the transaction.

2. The information processing device according to claim 1, wherein the processor is further configured to execute a payment process for the transaction upon receipt of the payment request when the flag data indicates the first value.

3. The information processing device according to claim 2, wherein the processor is further configured to update the flag data to the first value upon receipt of release data in association with the transaction after the notification is issued.

4. The information processing device according to claim 2, wherein the release data is acquired by and received from the mobile terminal.

5. The information processing device according to claim 4, wherein the release data is read from a medium held by a store clerk.

6. The information processing device according to claim 1, further comprising:
a communication interface configured to communicate with a monitoring terminal operated by a store clerk, wherein
the processor is further configured to control the communication interface to transmit the notification to the monitoring terminal.

7. The information processing device according to claim 1, wherein the processor is further configured to cause the mobile terminal to display a guidance screen indicating that the commodity requires confirmation by a store clerk upon determining that the commodity requires the confirmation.

8. The information processing device according to claim 1, wherein the processor is further configured to cause the mobile terminal to display a confirmation screen that guides the customer to contact a store clerk upon receipt of the payment request when the flag data indicates the second value.

9. The information processing device according to claim 8, wherein the processor is further configured to cause the mobile terminal to display, after the confirmation screen is displayed, a release screen through which a predetermined symbol can be input by a store clerk.

10. The information processing device according to claim 9, wherein the processor is further configured to cause the mobile terminal to display a checkout screen through which a payment method can be selected after the predetermined symbol is input.

11. A method of an information processing device in a point of sales (POS) system in which a commodity can be registered for purchase and a payment request for the commodity can be issued using a mobile terminal operated by a customer in a store, the method comprising:
storing flag data indicating either a first value indicating that none of commodities that have been registered requires confirmation by a store clerk when payment is made or a second value indicating that at least one of the commodities requires the confirmation;
after a sales transaction is started by the customer using the mobile terminal, initializing the flag data to the first value;
in response to a request for registering a commodity from the mobile terminal, determining whether the commodity requires confirmation by a store clerk;
after determining that the commodity requires the confirmation, updating the flag data to the second value;
in response to a payment request in association with the transaction, determining whether the flag data indicates the second value; and
after determining that the flag data indicates the second value, issuing a notification for notifying a store clerk that confirmation is required before completing the transaction.

12. The method according to claim 11, further comprising:
after determining that the flag data indicates the first value, executing a payment process on the transaction.

13. The method according to claim 12, further comprising:
after the notification is issued, receiving release data in association with the transaction and updating the flag data to the first value.

14. The method according to claim 12, wherein the release data is acquired by and received from the mobile terminal.

15. The method according to claim 14, wherein the release data is read from a medium held by a store clerk.

16. The method according to claim 11, further comprising:
transmitting the notification to a monitoring terminal operated by a store clerk.

17. The method according to claim 11, further comprising:
after determining that the commodity requires the confirmation, causing the mobile terminal to display a guidance screen indicating that the commodity requires confirmation by a store clerk.

18. The method according to claim 11, further comprising:
after determining that the flag data indicates the second value, causing the mobile terminal to display a confirmation screen that guides the customer to contact a store clerk.

19. The method according to claim 18, further comprising:
after the confirmation screen is displayed, causing the mobile terminal to display a release screen through which a predetermined symbol can be input by a store clerk.

20. A point of sales (POS) system in which a commodity can be registered for purchase and a payment request for the commodity can be issued using a mobile terminal operated by a customer in a store, the POS system comprising:
a monitoring terminal operated by a store clerk; and
an information processing device including:
a memory that stores flag data indicating either a first value indicating that none of commodities that have been registered requires confirmation by a store clerk when payment is made or a second value indicating that at least one of the commodities requires the confirmation, and
a processor configured to:
when a sales transaction is started by the customer using the mobile terminal, initialize the flag data to the first value,
upon receipt of a request for registering a commodity from the mobile terminal, determine whether the commodity requires confirmation by a store clerk,
upon determining that the commodity requires the confirmation, update the flag data to the second value, and
upon receipt of a payment request in association with the transaction, when the flag data indicates the second value, issue to the monitoring terminal a notification for notifying the store clerk that confirmation is required before completing the transaction.
